(19) United States
(12) Patent Application Publication
(10) Pub. No.: US 2025/0377757 A1
(43) Pub. Date: Dec. 11, 2025

(54) USER INTERFACES FOR VIEWS OF CALENDAR APPLICATIONS

(71) Applicant: Apple Inc., Cupertino, CA (US)

(72) Inventors: Christopher D. SOLI, San Francisco, CA (US); Mayura D. DESHPANDE, San Carlos, CA (US); Alexander J. O'CONNELL, Lafayette, CA (US); Daamun MOHSENI, Campbell, CA (US); Stephen O. LEMAY, Palo Alto, CA (US)

(21) Appl. No.: 19/215,202

(22) Filed: May 21, 2025

Related U.S. Application Data
(60) Provisional application No. 63/656,958, filed on Jun. 6, 2024.

(51) Int. Cl. G06F 3/0481; G06Q 10/1093

(52) U.S. Cl. CPC G06F 3/0481; G06Q 10/1093

(57) ABSTRACT

In some embodiments, an electronic device displays a plurality of views of a user interface for a calendar application. In some embodiments, an electronic device displays a representation of a calendar item in accordance with the type of the calendar item. In some embodiments, an electronic device displays a visual indication corresponding to one or more events. In some embodiments, an electronic device displays a visual indication corresponding to one or more events with one or more visual characteristics to indicate association with one or more calendars.

### CROSS-REFERENCE TO RELATED APPLICATIONS

This application claims the benefit of U.S. Provisional Application No. 63/656,958, filed Jun. 6, 2024, the entire disclosure of which is herein incorporated by reference for all purposes.

### FIELD OF THE DISCLOSURE

This disclosure relates generally to an electronic device presenting user interfaces for calendar applications.

### BACKGROUND OF THE DISCLOSURE

User interaction with electronic devices has increased significantly in recent years. These devices can be devices such as computers, tablet computers, televisions, multimedia devices, or mobile devices. In some circumstances, users may wish to display a user interface for a calendar application. The user may therefore desire efficient ways of displaying the user interface for the calendar application.

### SUMMARY OF THE DISCLOSURE

Providing efficient ways of displaying views of a user interface for a calendar application enhances user interactions with the electronic device by reducing the time and inputs needed to view information represented by the user interface. Providing efficient ways of representing calendar items enhances user interactions with the electronic device by reducing time and inputs needed to determine the corresponding type of the calendar item and/or reducing inputs otherwise required to change a status associated with the calendar item.

The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6D illustrate exemplary ways in which an electronic device displays a plurality of views of a calendar user interface in accordance with some embodiments of the disclosure.

FIG. 7 illustrates a flow diagram illustrating a method in which an electronic device displays a plurality of views of a calendar user interface in accordance with some embodiments of the disclosure.

FIGS. 8A-8R illustrate exemplary ways in which an electronic device displays representations of calendar items according to some embodiments.

FIG. 9 illustrates a flow diagram illustrating a method in which an electronic device displays representations of calendar items according to some embodiments.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used, and structural changes are optionally made without departing from the scope of the disclosed embodiments.

Providing efficient ways of displaying views of a user interface for a calendar application enhances user interactions with the electronic device by reducing the time and inputs needed to view information represented by the user interface. Providing efficient ways of representing calendar items enhances user interactions with the electronic device by reducing time and inputs needed to determine the corresponding type of the calendar item and/or reducing inputs otherwise required to change a status associated with the calendar item.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted device (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

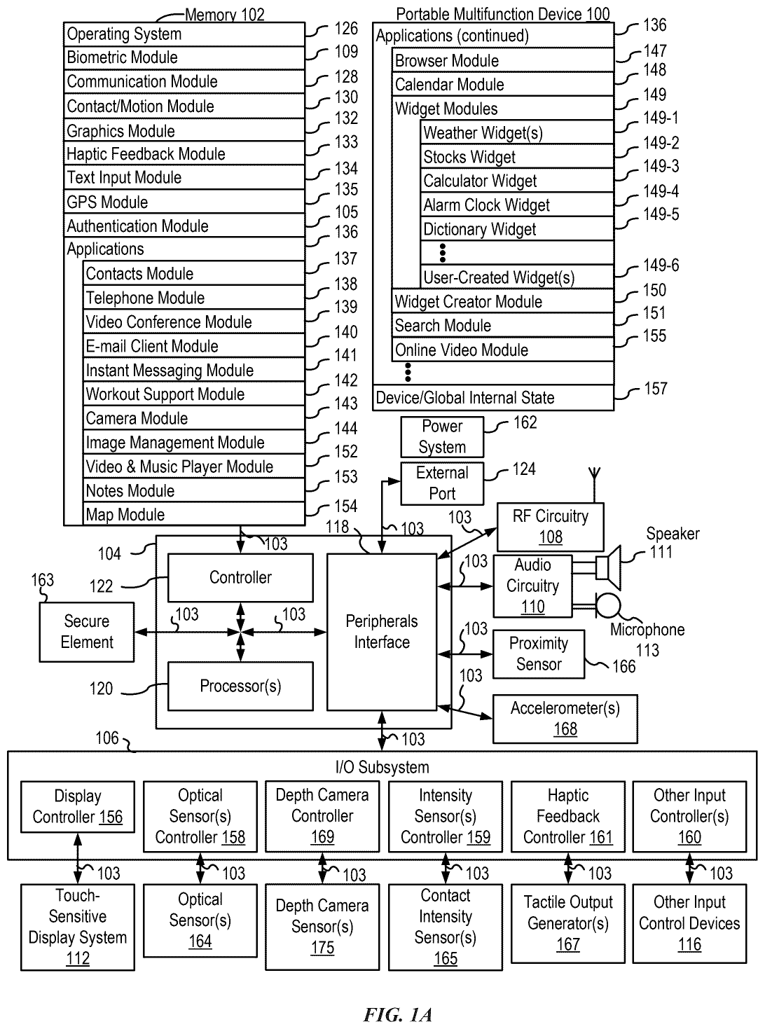

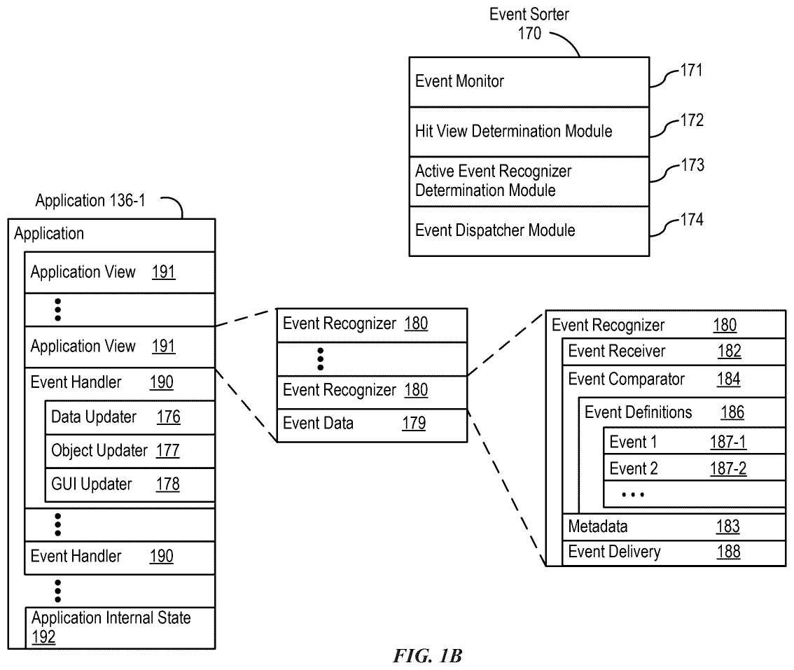

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive display 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to one or more processing units 120 and memory 102. The one or more processors 120 run or execute various software programs and/or sets of instructions stored in memory 102 to perform various functions for device 100 and to process data.

In some embodiments, peripherals interface 118, one or more processing units 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

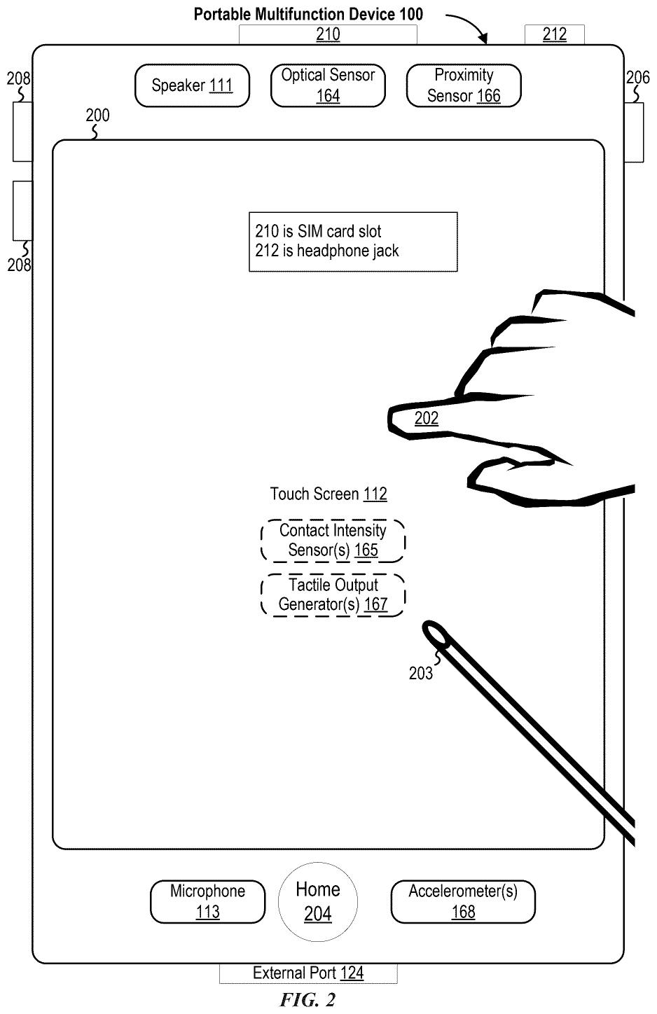

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch-sensitive display 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch-sensitive display 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch-sensitive display 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch-sensitive display 112. Touch-sensitive display 112 displays visual output to the user. The visual output optionally includes graphics, text, icons, video, and any combination thereof (collectively termed “graphics”). In some embodiments, some or all of the visual output corresponds to user-interface objects.

Touch-sensitive display 112 has a touch-sensitive surface, sensor or set of sensors that accepts input from the user based on haptic and/or tactile contact. Touch-sensitive display 112 and display controller 156 (along with any associated modules and/or sets of instructions in memory 102) detect contact (and any movement or breaking of the contact) on touch-sensitive display 112 and convert the detected contact into interaction with user-interface objects (e.g., one or more soft keys, icons, web pages or images) that are displayed on touch-sensitive display 112. In an exemplary embodiment, a point of contact between touch-sensitive display 112 and the user corresponds to a finger of the user.

Touch-sensitive display 112 optionally uses LCD (liquid crystal display) technology, LPD (light emitting polymer display) technology, or LED (light emitting diode) technology, although other display technologies are used in other embodiments. Touch-sensitive display 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch-sensitive display 112 is, optionally, analogous to the multi-touch sensitive touchpads described in the following U.S. Pat. No. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch-sensitive display 112 displays visual output from device 100, whereas touch-sensitive touchpads do not provide visual output.

A touch-sensitive display in some embodiments of touch-sensitive display 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. Patent application Ser. No. 11/48,264, “Gestures For Touch Sensitive Input Devices,” filed Jan. 31, 2005; (5) U.S. Patent application Ser. No. 11/38,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch-sensitive display 112 optionally has a video resolution in excess of 100 dpi. In some embodiments, the touch screen has a video resolution of approximately 160 dpi. The user optionally makes contact with touch-sensitive display 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch-sensitive display 112 when the multifunction device is placed near the user's car (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

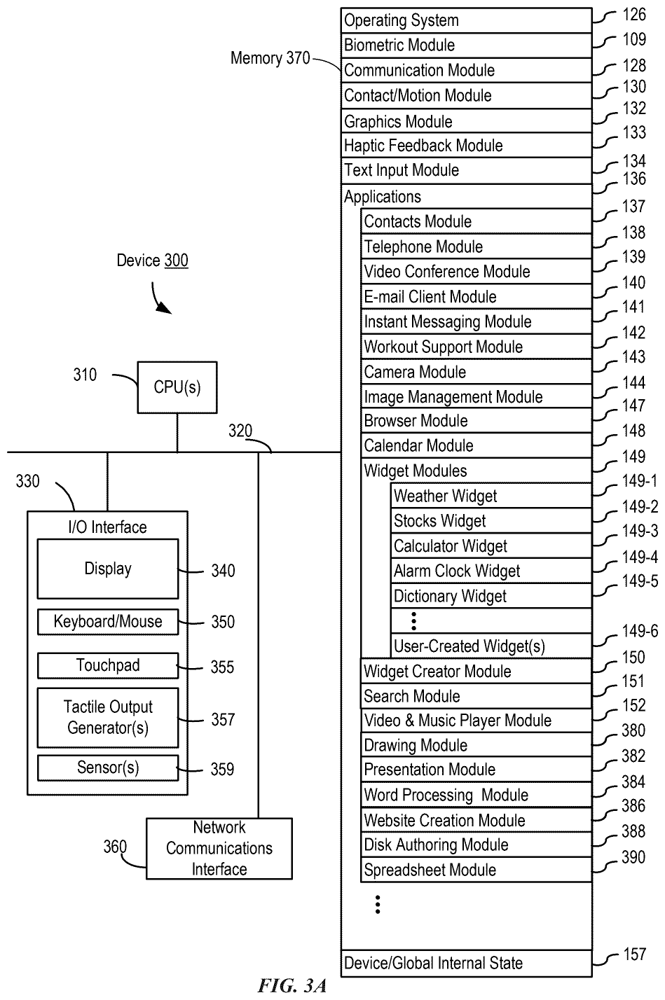

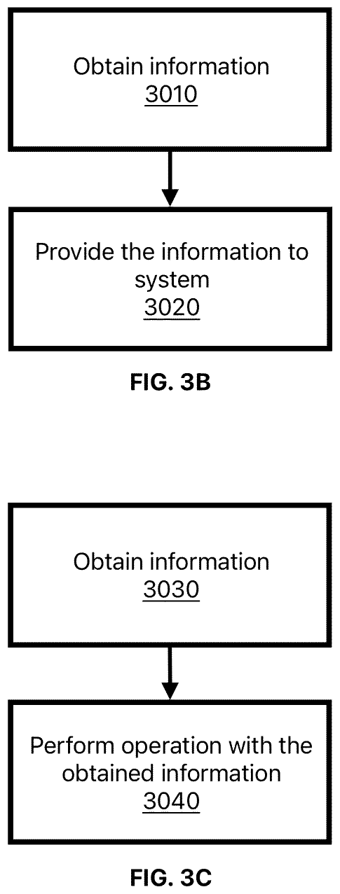

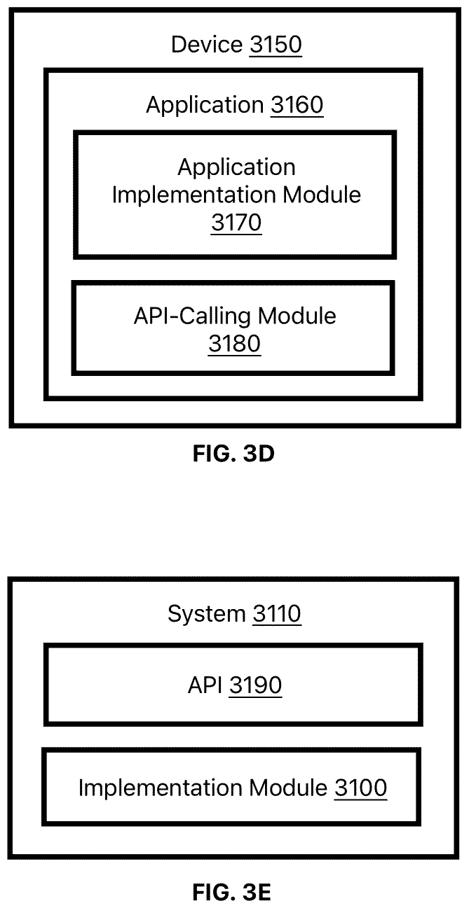

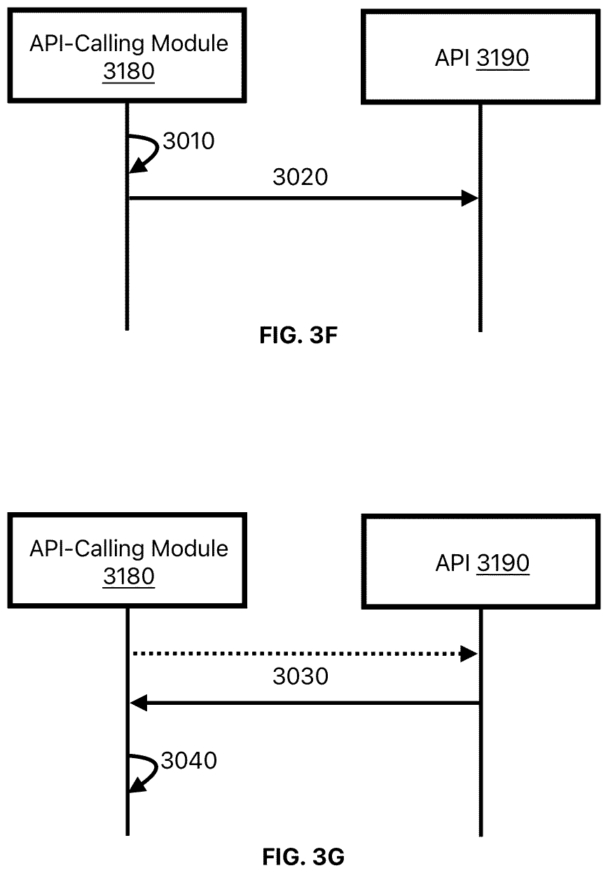

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch-sensitive display 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch-sensitive display 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM module 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM module 141; and so forth.

In conjunction with RF circuitry 108, audio circuitry 110, speaker 111, microphone 113, touch-sensitive display 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch-sensitive display 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch-sensitive display 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch-sensitive display 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch-sensitive display 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch-sensitive display 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch-sensitive display 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch-sensitive display 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch-sensitive display 112 or on an external, connected display via external port 124). In some embodiments, device 100 optionally includes the functionality of an MP3 player, such as an iPod (trademark of Apple Inc.).

In conjunction with touch-sensitive display 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch-sensitive display 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch-sensitive display 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. Patent application Ser. No. 11/968,67, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications and/or modules 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch-sensitive display 112 in accordance with some embodiments. As stated above, multifunction device 100 is described as having the various illustrated structures (such as touch-sensitive display 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch-sensitive display 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch-sensitive display 112.

In one embodiment, device 100 includes touch-sensitive display 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch-sensitive display 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

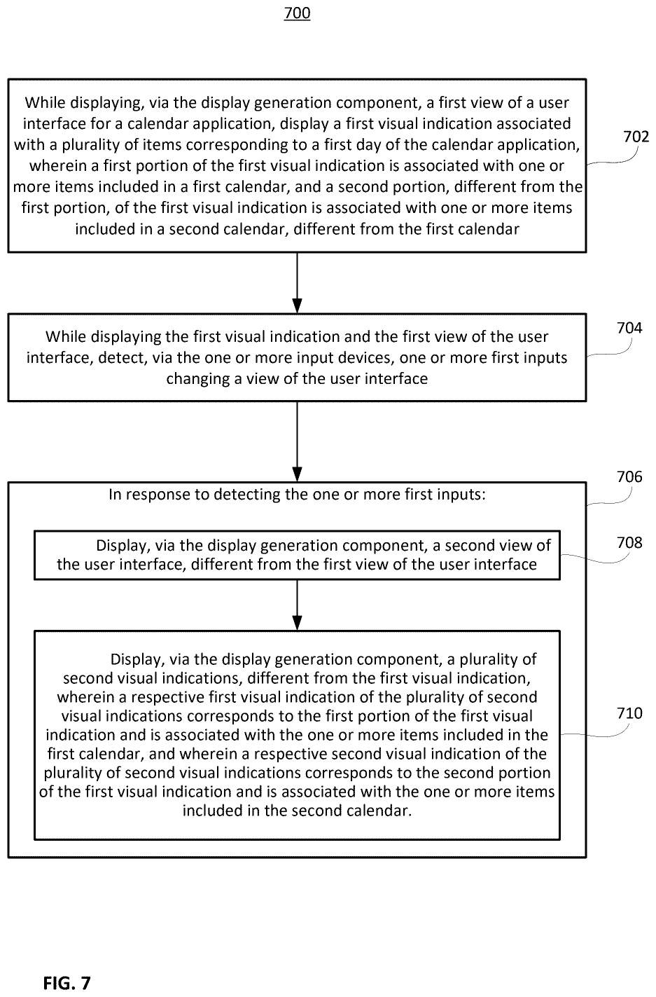

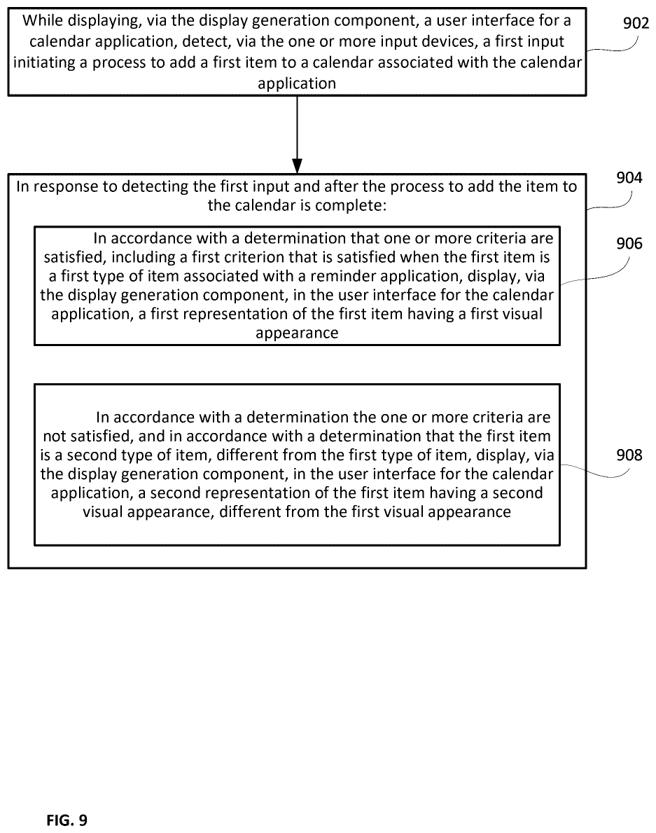

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) and/or method 900 (FIG. 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

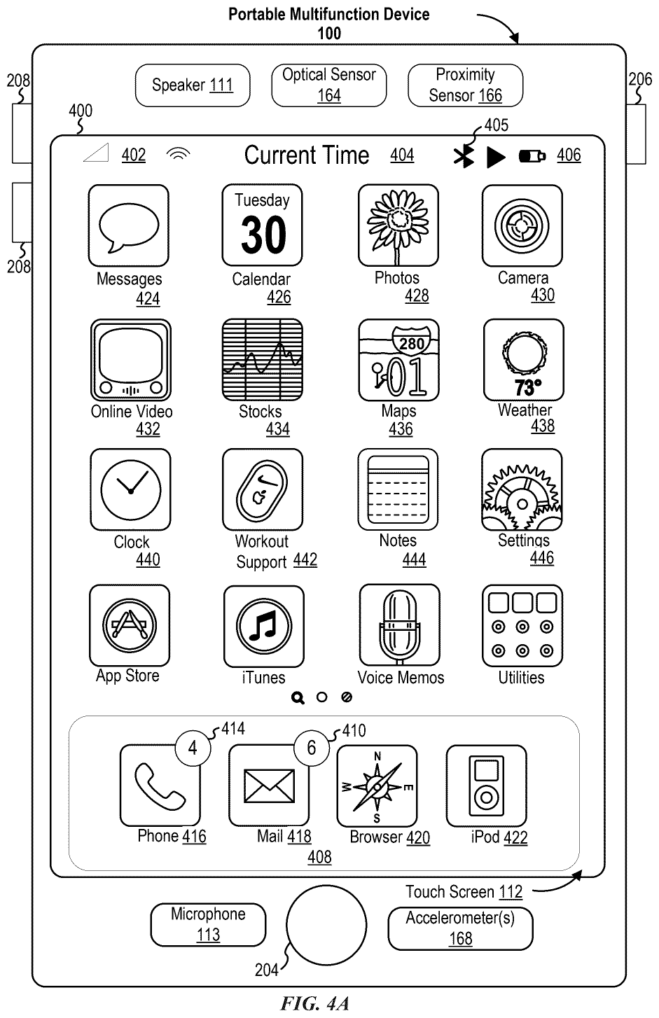

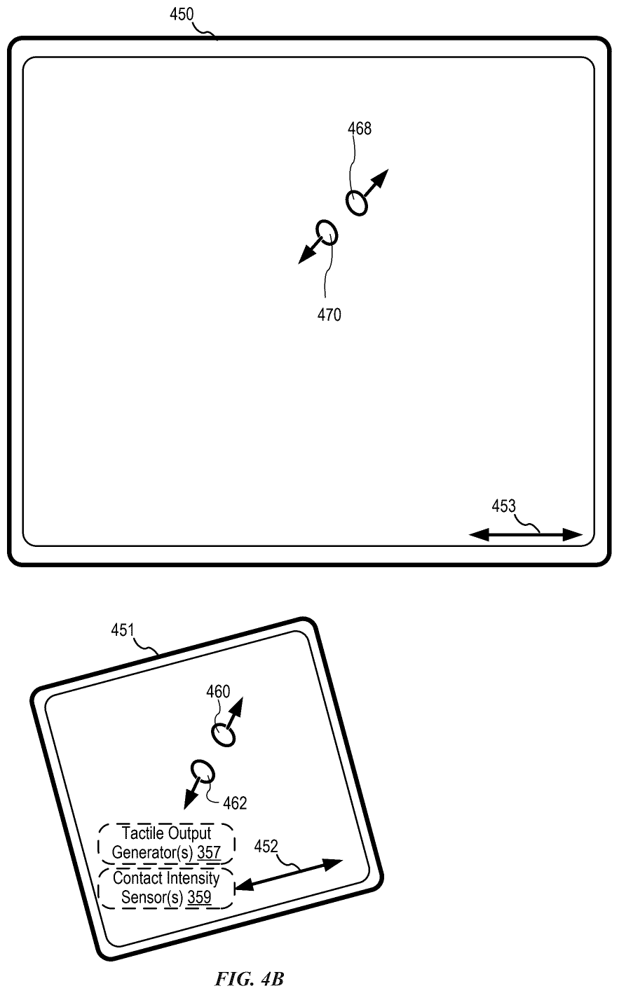

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

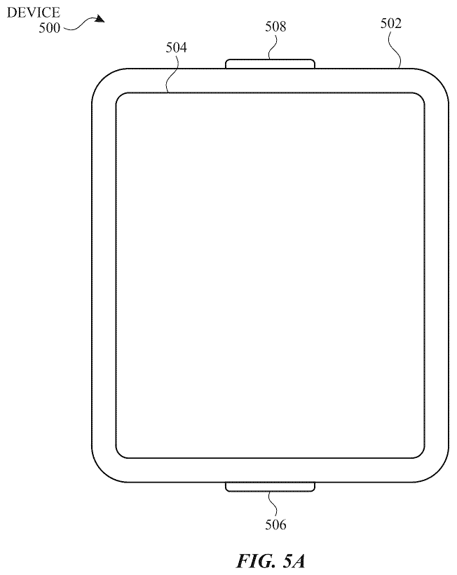

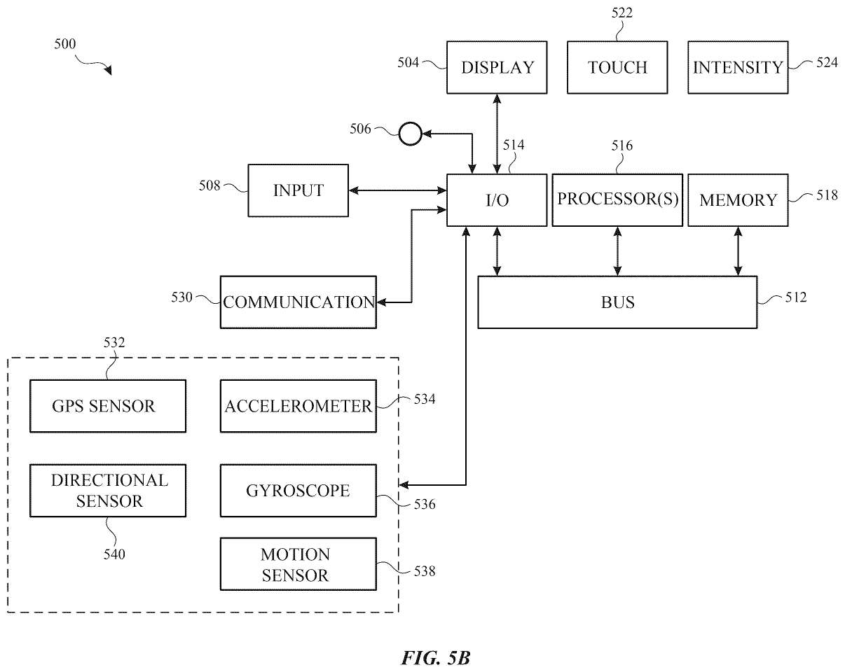

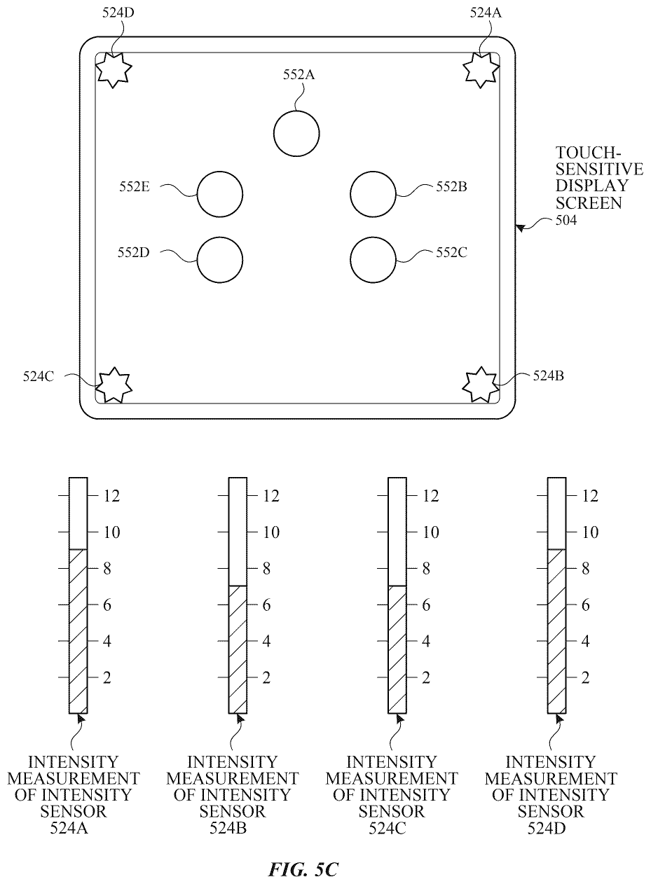

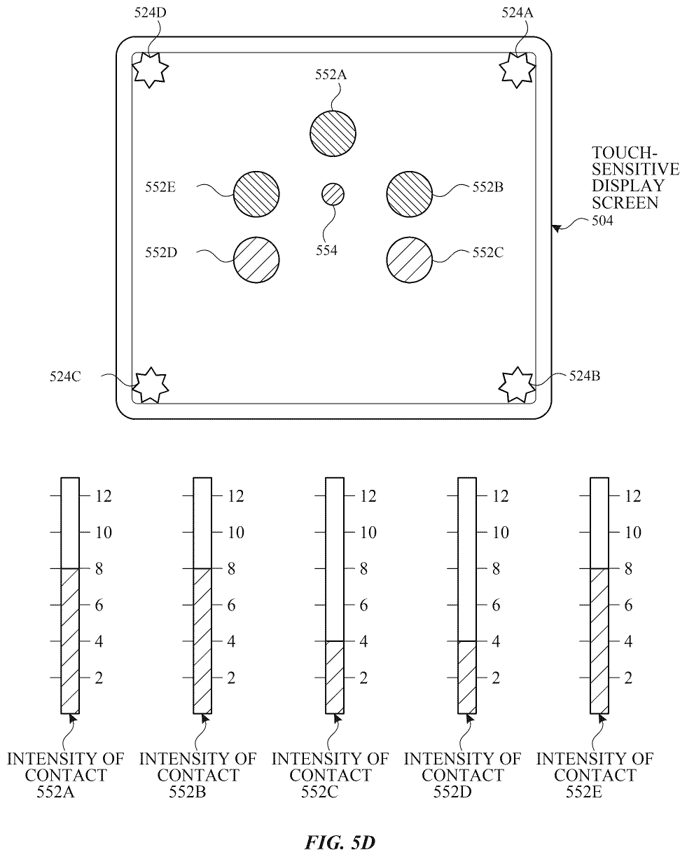

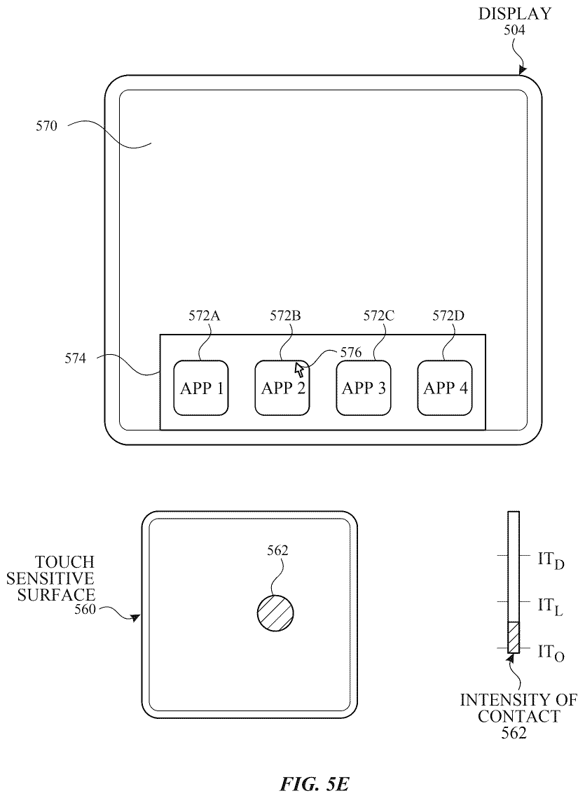

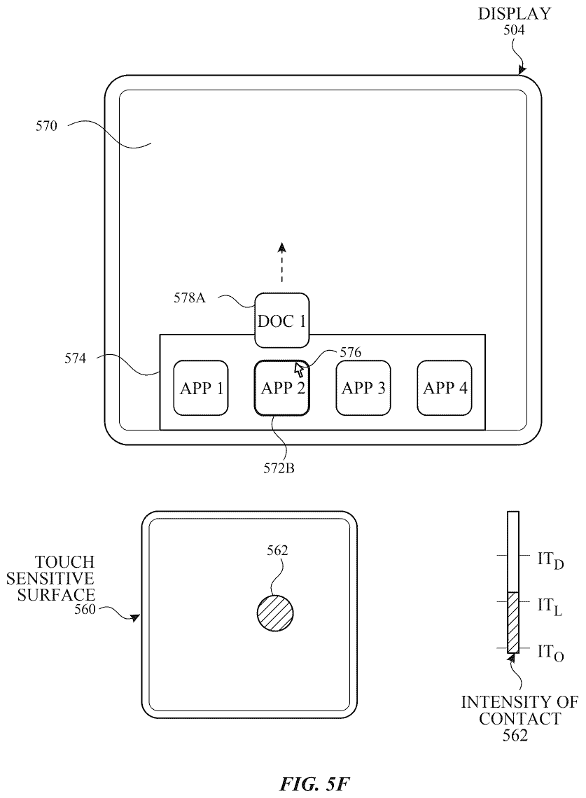

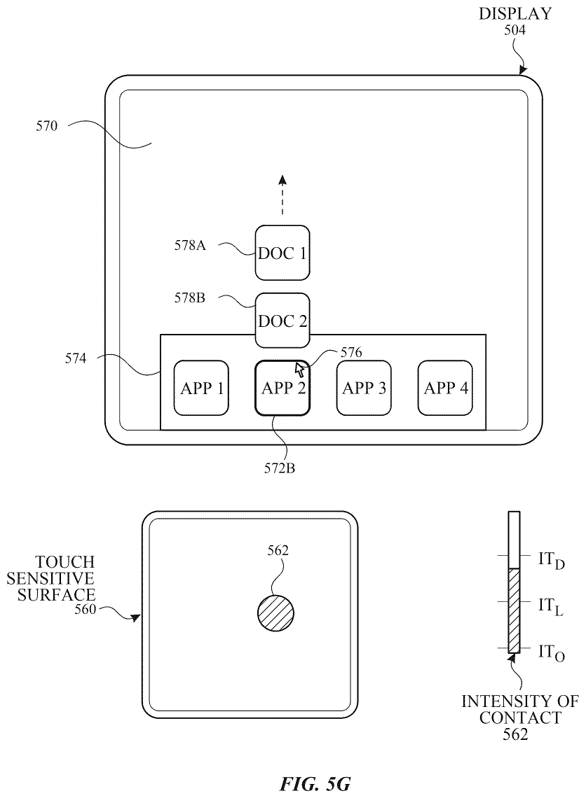

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 516 optionally execute any number of programs stored in memory 506 or storage, which optionally includes instructions to perform one or more of the methods and/or processes described herein (e.g., methods 700 and/or 900). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch-sensitive display 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and EDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D})”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D})”). Contact 562 is maintained on touch-sensitive surface 560. In response to the detection of the gesture, and in accordance with contact 562 having an intensity that goes above the deep press intensity threshold (e.g., “IT_{D})”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D})”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

Users interact with electronic devices in many different manners. In some embodiments, an electronic device is in communication with one or more input devices, a display generation component, and wireless circuitry. In some embodiments, the electronic device presents a user interface associated with a calendar application. The embodiments described below provide ways in which an electronic device displays a plurality of views of the user interface associated with the calendar application. Displaying different views of the user interface associated with the calendar application reduces user input otherwise required to gain an understanding about activity represented in the user interface for the calendar. It is understood that people use devices. When a person uses a device, that person is optionally referred to as a user of the device.

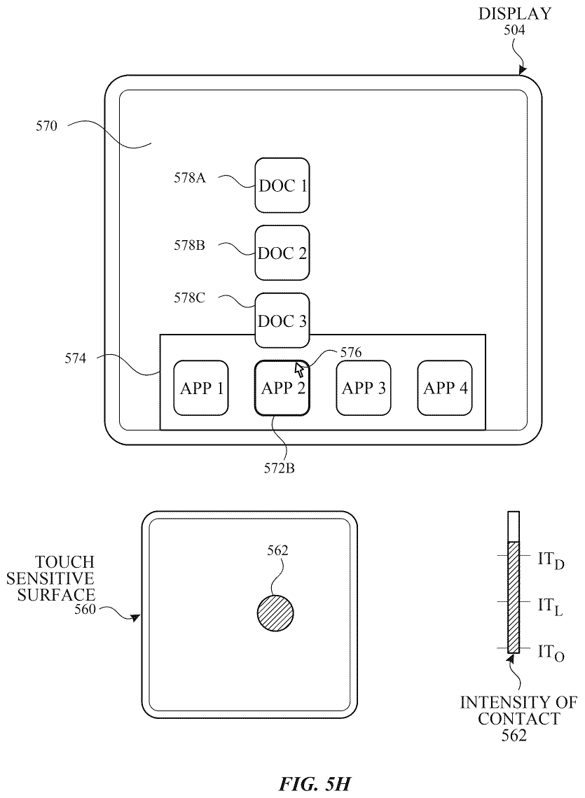

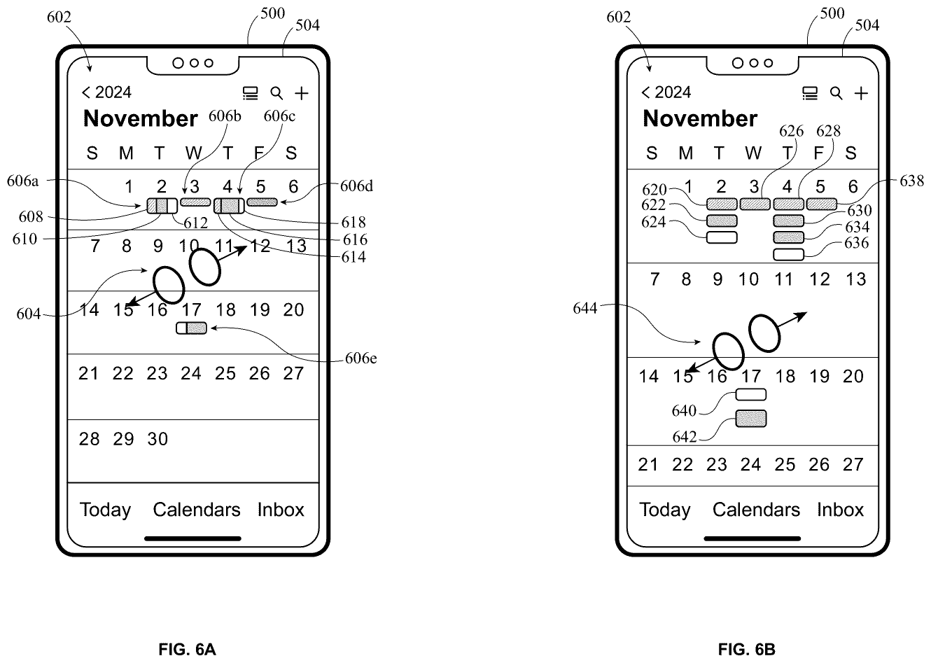

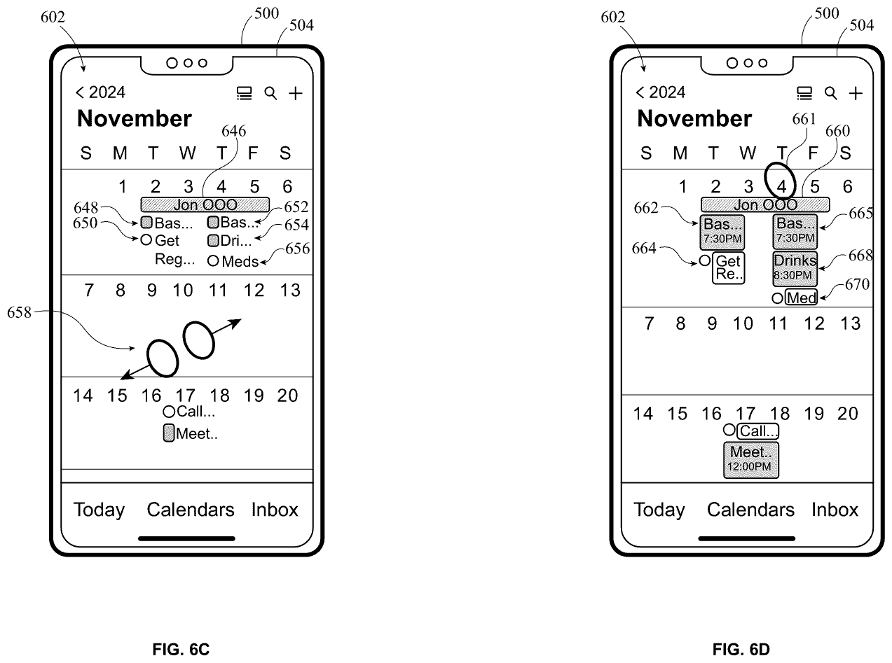

FIGS. 6A-6D illustrate exemplary ways in which an electronic device displays views of a representation of a calendar and displays representation of calendar items. The embodiments in these figures are used to illustrate the processes described below, including the processes described with reference to FIG. 7 and/or FIG. 9. Although FIGS. 6A-6D illustrate various examples of ways an electronic device is able to perform the processes described below with respect to FIG. 7, it should be understood that these examples are not meant to be limiting, and the electronic device is able to perform one or more processes described below with reference to FIG. 7 in ways not expressly described with reference to FIGS. 6A-6D.

FIG. 6A illustrates embodiments of a user interface for a calendar application. FIG. 6A illustrates an electronic device 500 that is in communication with a display generation component 504 (e.g., a touchscreen). In some embodiments, the electronic device 500 is a mobile device, such as a smartphone, tablet, or wearable device. In some embodiments, display generation component 504 is a touchscreen, a non-touch sensitive display, and/or a projected display in which images are cast into a physical environment of a user of the electronic device 500.

In FIG. 6A, electronic device 500 displays user interface 602, which optionally corresponds to a user interface for a calendar application. For example, user interface 602 in FIG. 6A includes text describing a currently displayed month, year, and days of the week that are being represented (e.g., “M” for Monday, “T” for Tuesday, and the like). As described further herein with reference to method 700, the arrangement of days and/or calendar items represented optionally corresponds to a “view” of user interface 602. For example, in FIG. 6A, electronic device 500 displays a first view of a representation of a calendar. The first view optionally includes a representation of every day in a month, text identifying the dates that are represented, and/or includes the five different weeks that are included in the month of November 2024.

In some embodiments, the view of user interface 602 includes the arrangement of days and/or weeks. For example, in FIG. 6A, the first view includes displaying every week that is included in November, as opposed to the view of user interface 602 illustrated in FIG. 6C which includes three weeks. In some embodiments, electronic device 500 manages display of representations of calendar items—at times referred to herein as calendar items for brevity-sourced from one or more instances of calendars that are managed by the calendar application. For example, as described further with reference to method 700, electronic device 500 stores and/or receives indications of calendar items including calendar events and/or reminders associated with a work calendar instance, a personal calendar instance, a school schedule instances, and/or the like. In some embodiments, electronic device 500 displays representations of the items. In some embodiments, electronic device 500 visually indicates which instance of a calendar particular calendar items correspond to. For example, in FIG. 6A, electronic device 500 displays representation 606a, corresponding to a representation of a plurality of calendar items corresponding to a first day (e.g., November 2^{nd}). Representation 606a optionally includes a plurality of portions, indicating that a plurality of items corresponding to a plurality of calendar instances fall on that day. Thus, in the first view of user interface 602 in FIG. 6A, electronic device 500 optionally indicates that one or more items fall on respective days, as indicated by representations 606a, 606b, 606c, 606d, and/or 606e. In some embodiments, electronic device 500 visually indicates which-if any-days represented in user interface 602 correspond to the current day. For example, in accordance with a determination that a system clock at electronic device 500 corresponds to Nov. 2, 2024, electronic device 500 optionally visually distinguishes the day, such as by changing a color and/or fill pattern at least partially overlapping the day, displaying a shape and/or other visual indication around at least a portion of the day, and/or changes a scale of information such as text including the day (e.g., “2”). As one of many examples, the electronic device 500 optionally displays a circular shape surrounding the text indicating the day, such as a red circle, a green box, and/or the like.

In some embodiments, when displaying the first view of user interface 602, electronic device 500 displays a single visual indication when at least one calendar item falls on a day. For example, representation 606b visually indicates that at least one calendar item falls on a second day, different from the first day described above (e.g., November 3^{rd}). Similarly, in FIG. 6A, user representation 606c indicates that a plurality of calendar items falls on a third day, representation 606d indicates that one or more items fall on a fourth day, and representation 606e indicates that a plurality of calendar items fall on a fifth day. In the first view of the user interface 602, days that do not include respective visual indications optionally indicate that there are not items from a calendar instance that fall on that day; accordingly, electronic device 500 does not display visual indications corresponding to those days.

In some embodiments, when displaying the first view of user interface 602, electronic device 500 displays one or more portions of the visual indication that falls on a day to indicate one or more calendar items correspond to the day to respective days included in the first view of user interface 602 in FIG. 6A. For example, representation 606a includes a first portion 608, a second portion 610, and a third portion 612. In some embodiments, as described further with reference to method 700, portions of a representation are displayed with one or more visual characteristics to indicate a source calendar instance that corresponds to the item(s) represented by a given portion. For example, in FIG. 6A, the first view of user interface 602 includes representation 606a displayed with a plurality of portions, such as portion 608 displayed with first fill pattern corresponding to a first calendar instance, includes a second portion 610 displayed with a second fill pattern corresponding to a second calendar instance, and includes third portion 612 displayed with a third fill pattern corresponding to a third calendar instance. Thus, in FIG. 6A, representation 606a is a representation that optionally indicates that a plurality of calendar items from a plurality of instances of calendars correspond to that day.

Similarly to as described above, representation 606c includes a first portion 614, a second portion 616, and a third portion 618. Because calendar items represented in the first view correspond to the same calendar instances as those represented in representation 606a, electronic device 500 displays the respective portions of representation 606c with fill patterns that are the same as those includes in representation 606a. For example, first portion 608 is the same fill pattern as first portion 614, second portion 610 is the same fill pattern as second portion 616, and third portion 612 is the same fill pattern as portion 618. Additionally or alternatively, representation 606b and 606d respectively include a single portion that corresponds to the first calendar, and accordingly is displayed with the first fill pattern corresponding to the first calendar instance. Additionally or alternatively, representation 606e includes a plurality of portions that respectively include fill pattern that correspond to the second and/or third calendar.

In some embodiments, one or more visual characteristics of visual indications included in the first view of user interface 602 are changed in accordance with the density and/or quantity of calendar items that correspond to a given day, as described further with reference to method 700. As described with reference to method 700, a density of calendar items optionally includes the quantity of items that correspond to the day, and/or the quantity of items relative to a period of time (e.g., an hour, two hours, three hours, six hours, twelve hours, and/or twenty-four hours) scheduled for that day. As one example, when during a working period (e.g., 8:00 AM-5:00 PM) of a first day, in accordance with a determination a first quantity of items is scheduled for times during the working period, the calendar item density is a first density. In accordance with a determination that a second quantity of items, different from the first quantity, are scheduled for times during the working period, the calendar item density is a second density, different from the first (e.g., a greater number of items corresponds to a relatively greater density, and vice-versa). For example, a vertical height relative to user interface 602 is varied in the first view of the user interface in accordance with the relative density of calendar items corresponding to different days in FIG. 6A. Representation 606a, for example, is displayed with a first height, similar to or the same as a height of representation 606c. Additionally or alternatively, because the representation 606b corresponds to a day in which there are relatively fewer calendar items and/or in which the items are scheduled for times that are spread further apart from each other, representation 606b in FIG. 6A is displayed with a height that is relatively less than representation 606a and/or representation 606d. Similarly, representation 606d is displayed with a height that is similar to representation 606b, to convey that representation 606d is less calendar item-dense than the day corresponding to representation 606a and/or representation 606bc. Additionally or alternatively, representation 606e is displayed with a height less than the height of representation 606a and/or representation 606c, to indicate that the items corresponding to representation 606e are less dense on the fifth day corresponding to representation 606c.

In some embodiments, one or one or more visual characteristics of portions of the visual indications change in accordance with the density and/or quantity of calendar items that correspond to a given day, as described further with reference to method 700. For example, the relative width of the portion 608, second portion 610, and/or third portion 612 optionally vary in accordance with a determination that there is a relatively higher density of calendar items for instances of calendars that respectively correspond to the portions. In some embodiments, the relative widths of the portions are the same for a given representation of items for a day.

In some embodiments, electronic device 500 initiates display or forgoes display of visual indications and/or portions of visual indication in response to detecting input(s) enabling or disabling view of one or more instances of a calendar. For example, in response to detecting an input deselecting a work calendar instance from being displayed in user interface 602, the electronic device optionally forgoes display of a visual indication corresponding to a day at which there are no other items that correspond to that day, and/or optionally ceases display of a portion of a visual indication corresponding to an item that belongs to the deselected work calendar instance.

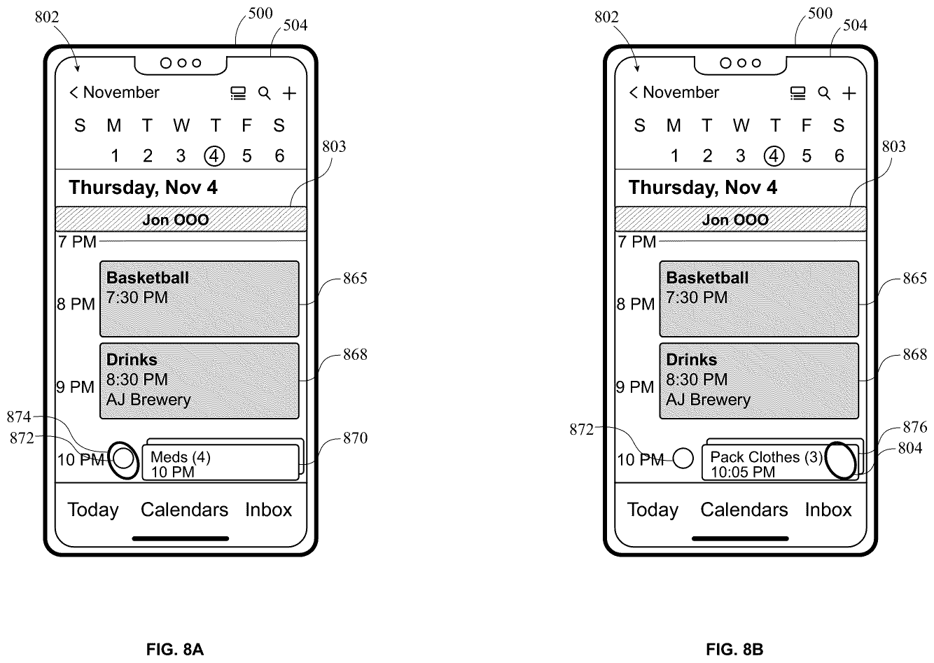

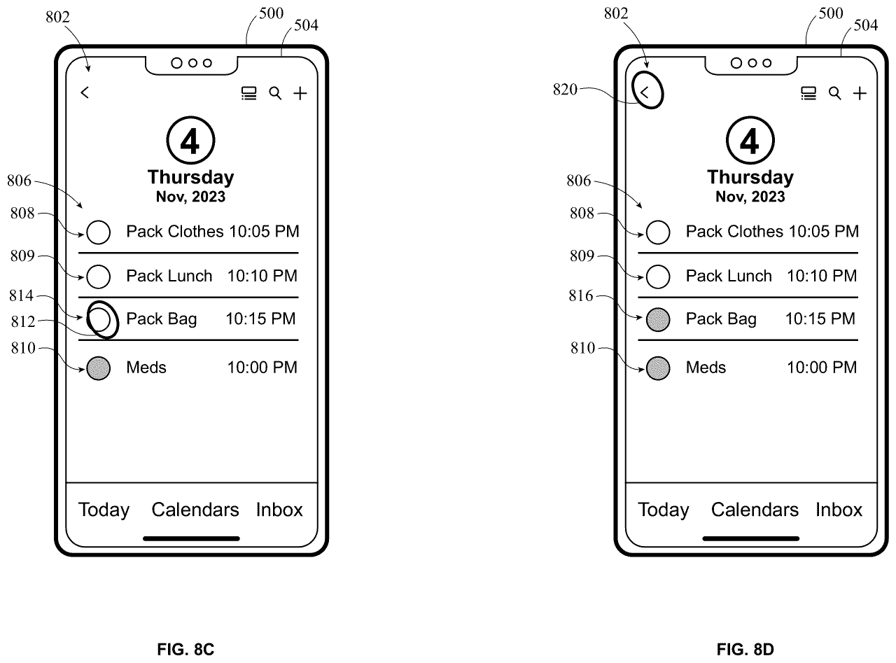

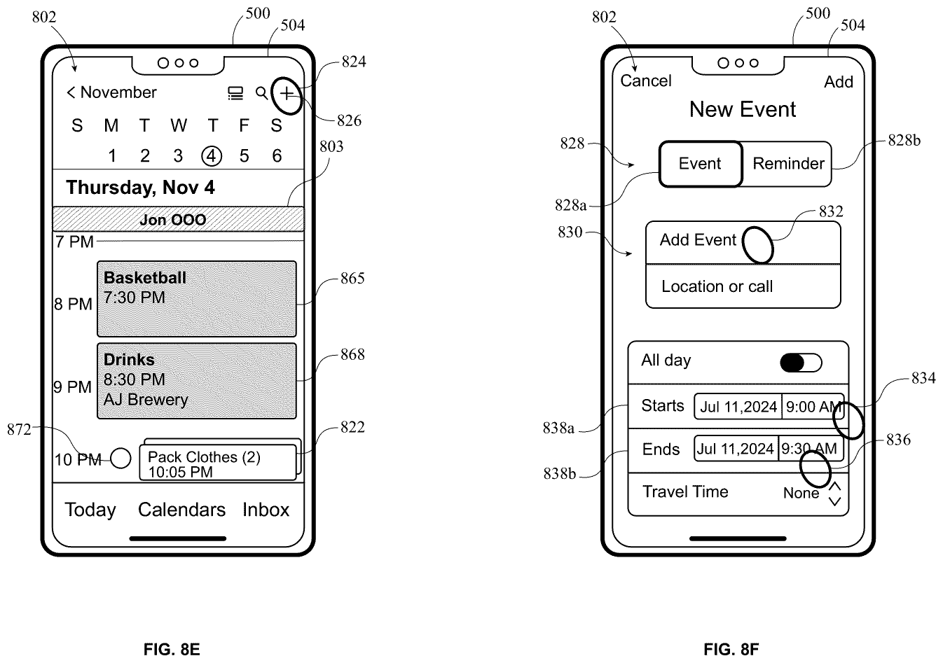

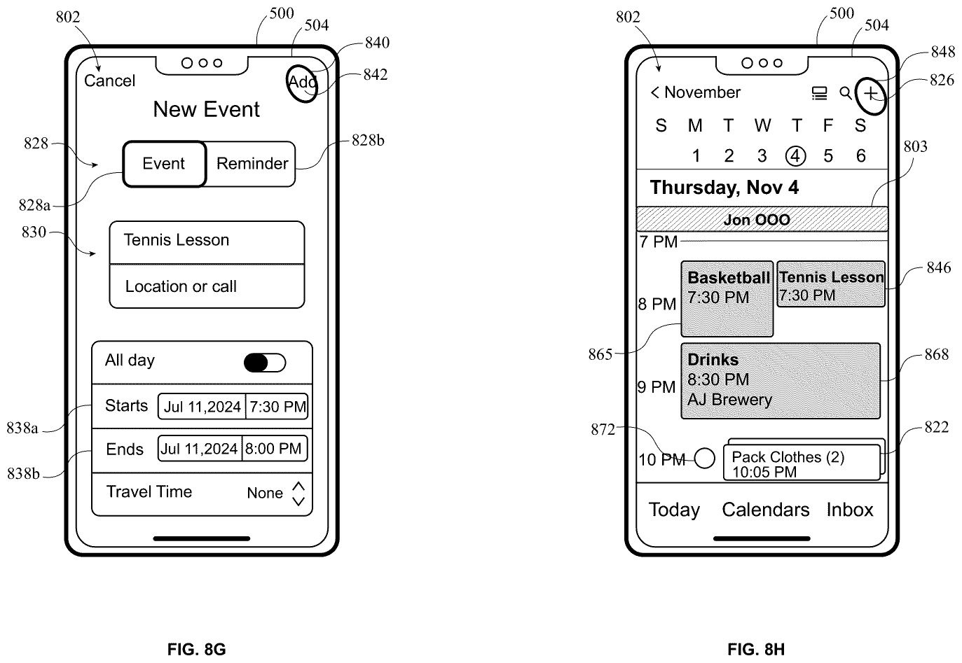

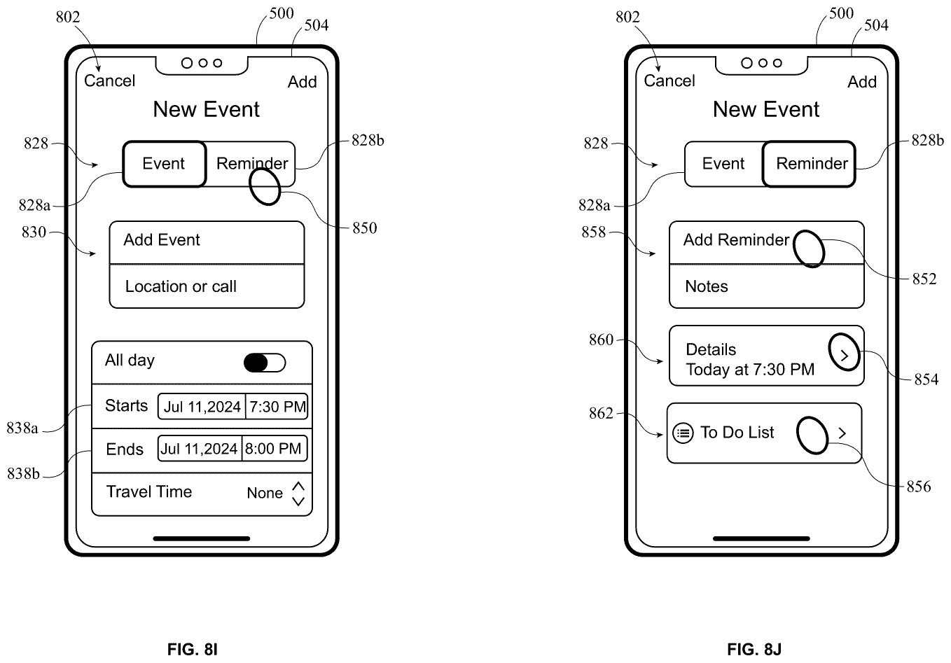

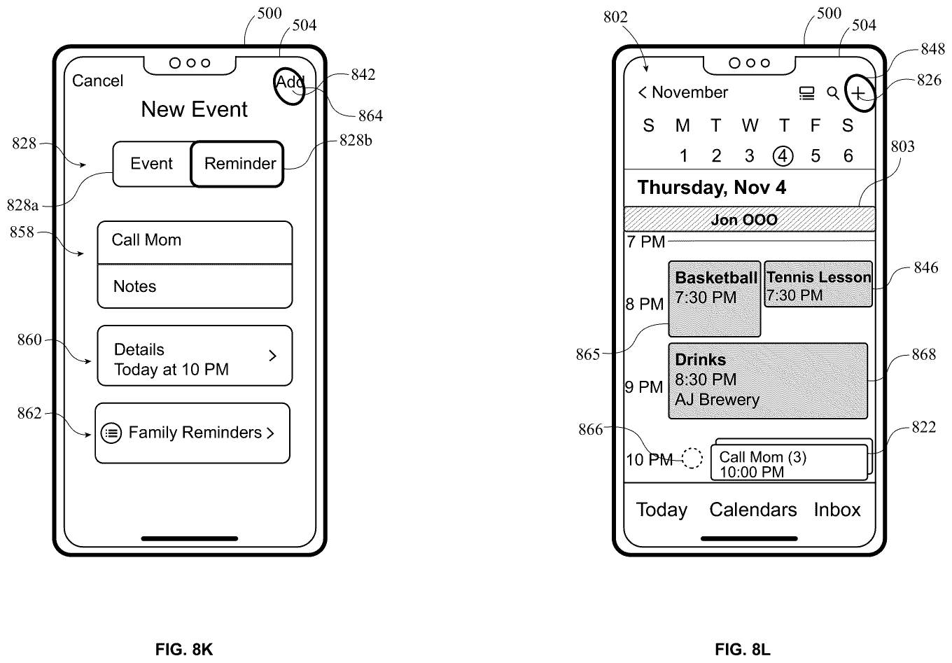

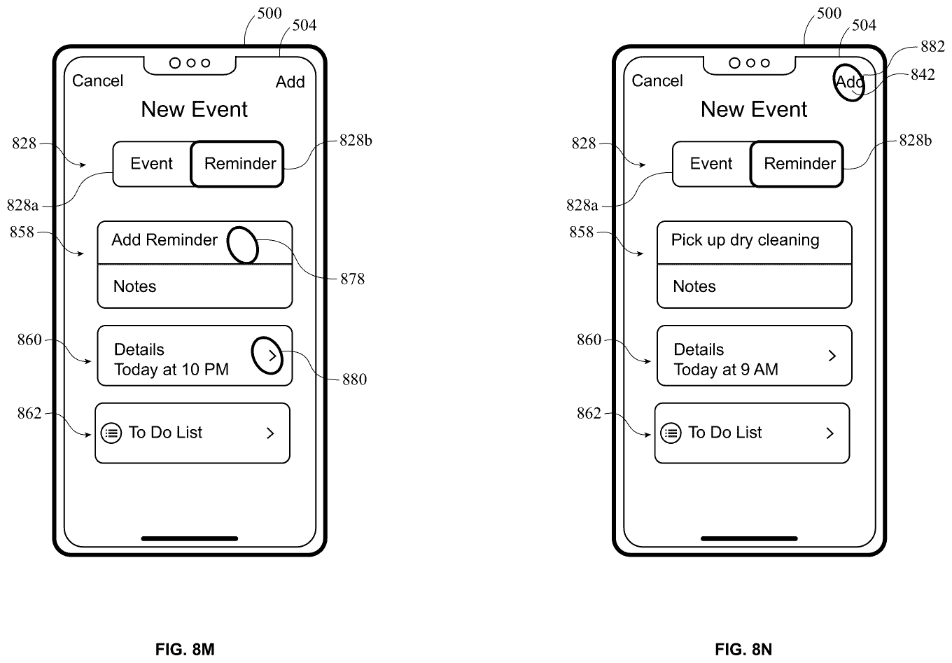

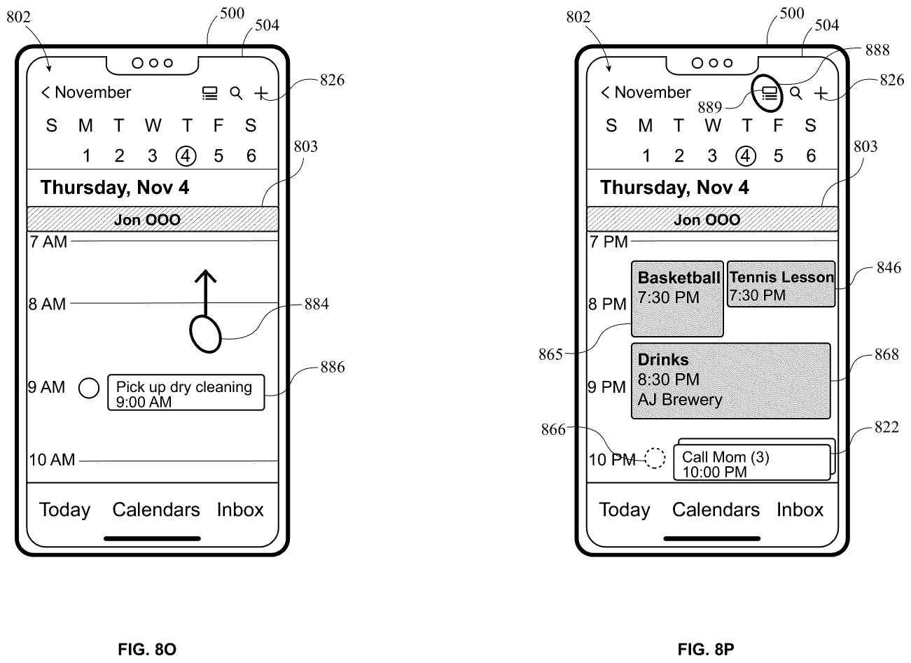

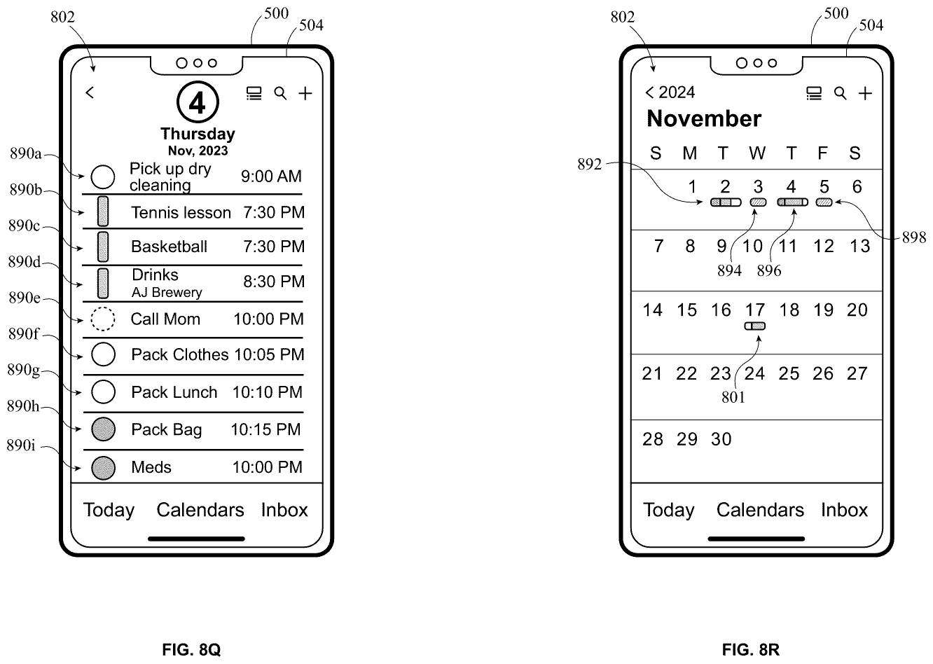

In some embodiments, the first view of user interface 602 includes indications of how calendar item dense a given day is, in a manner that is different from as illustrated in FIG. 6A. For example, FIG. 8R illustrates an embodiment in which the relative height of various representations are consistent for different days independently of calendar item density. In FIG. 8R, the relative density is optionally indicated by the relative width of the visual indications for each day. For example, representation 892 and representation 896 correspond to relatively higher density of calendar items and are consequentially wider, as compared to representation 894 and/or representation 898 (e.g., representation 894 and 898 correspond to lower item density days, and are relatively less wide). Similarly, representation 801 is optionally more item-dense than representation 894, but less item dense than representation 892, and accordingly is intermediate in width to the other representations.

Turning back to FIG. 6A, electronic device 500 detects input 604, indicative of two contacts on a touch screen corresponding to display generation component 504. In some embodiments, the movement of the two contacts correspond to a scaling up and/or a zooming in request, such as a request to change the display of user interface 602. Accordingly, as illustrated in FIG. 6B, electronic device 500 optionally changes the view of user interface 602 to correspond to a second view.

FIG. 6B illustrates a second view of a user interface for the calendar application. For example, in response to detecting input 604 in FIG. 6A, electronic device 500 optionally ceases display of the first view of user interface 602, and optionally initiates display of a second view of user interface 602 in FIG. 6B. As described further with reference to method 700, relative to the first view, the second view of user interface 602 optionally includes a different arrangement and/or scale of representation of days, and/or optionally includes a different manner in which the items are indicated.

One of many possible factors differentiating the first and second view optionally includes how many representations are displayed on a given day. For example, representation 606a from FIG. 6A optionally corresponds to representations 620, 622, and 624 in FIG. 6B (e.g., all of such representations correspond to the “first day” described with reference to FIG. 6A). In FIG. 6B, representation 620 corresponds to an item associated with the first calendar, and/or optionally corresponds to first portion 608 in FIG. 6A. Similarly, in FIG. 6B, representation 622 optionally corresponds to an item associated with the second calendar and/or corresponds to second portion 610 in FIG. 6A, and/or representation 624 optionally corresponds to an item associated with the third calendar and/or optionally corresponds to third portion 612 in FIG. 6A. Thus, in the second view of user interface 602, respective calendar items are optionally discretely represented, rather than represented in the aggregate as shown in the first view. In FIG. 6B, the relative width of respective representations corresponding to calendar items are optionally the same. In some embodiments, when transitioning between views of the user interface, electronic device 500 displays an animation in which portions of a representation in the first view are split and/or change in dimension into the representations of related items included in the second view. For example, electronic device 500 optionally displays an animation of the portions of representation 606a aligning, splitting, and/or expanding to occupy the width of the first day represented in the second view of user interface 602.

Similarly to as described above, representation 626 optionally corresponds to representation 606b, representation 638 optionally correspond to representation 606d, and/or representation 628, 630, 634, and 636 optionally correspond to representation 606c. Similarly to as described with reference to the first day, the individual representations included in the third day (e.g., representation 628, 630, 634, and 636) are optionally displayed with respective fill patterns that indicate which instance of calendar the representation respectively belong to, and/or map to the same fill patterns indicated in representation 606c in FIG. 6A. Additionally or alternatively, representation 640 and/or representation 642 are optionally displayed with respective fill patterns indicating their associated calendar instances, and/or the fill patterns are optionally the same as indicated by representation 606c.

In some embodiments, electronic device 500 changes the dimension and/or number of days included in a view of a user interface. For example, from FIG. 6A to FIG. 6B, electronic device 500 optionally changes a height of representation of days to allow room for the discretization of calendar items (e.g., instead of the aggregation in the first view in which portions of a same visual indication represent calendar items). In addition, from FIG. 6A to FIG. 6B, electronic device 500 optionally maintains a width of the representation of the days. Additionally, from FIG. 6A to FIG. 6B, electronic device 500 ceases display of the last week of November. In some embodiments, the particular week(s) that remain displayed when transitioning between weeks of the calendar correspond to the relative location of a scaling input. For example, because input 604 in FIG. 6A is centered on the week of November 7-13, electronic device optionally displays that same week in a relative center of the second view of user interface 602 in FIG. 6B. In some embodiments, the number of weeks is consistent between the first and/or the second views. In some embodiments, the height of representation of items included in the second view of the user interface are scaled such that a particular number of weeks are displayed (e.g., four weeks in the second view in FIG. 6B). In FIG. 6B, electronic device 500 detects input 644, which optionally has one or more characteristics similar to or the same as one or more characteristics of input 604.

FIG. 6C illustrates a third view of user interface 602 for the calendar application. In some embodiments, electronic device displays the third view in FIG. 6C in response to detecting input 644 in FIG. 6B. In some embodiments, the manners in which day(s), week(s), and/or calendar items are represented in the third view are different from the manner(s) in which similar entities are represented in the first and/or second views. For example, the third view in FIG. 6C includes text at least partially describing titles and/or information associated with calendar items that were not included in the first and/or the second views. Representations 648, 650, 652, and 654, for example, optionally include the initial portion of titles of corresponding items. Additionally or alternatively, the shapes of the representations are optionally different to convey a type of the related calendar item (as described with reference to methods 700 and/or 900, a reminder and/or a calendar event). For example, representation 648 is a first shaped icon, and representation 650 is a second shaped icon. In some embodiments, calendar items that span a plurality of days are displayed extending between the representations of days. For example, representation 646 optionally extends across the November 2^{nd} through November 4^{th} (e.g., the first and fourth day described with reference to FIG. 6A), because the corresponding item spans across those days (e.g., “Jon” is out of the office “OOO” for those days). Similarly to as described with reference to the difference between the first and the second views, the third view is optionally different from the other views at least with respect to the dimension and/or number of days represented. For example, the third view of user interface 602 in FIG. 6C optionally includes three weeks, rather than four or five weeks of the month. In FIG. 6C, electronic device 500 detects input 658, which is optionally similar to or the same as inputs 604 and/or 644.

FIG. 6D illustrates a fourth view of a user interface for a calendar application. For example, in response to detecting input 658 in FIG. 6C, electronic device 500 displays the fourth view in FIG. 6D. In some embodiments, similarly to as described with reference to the other views of user interface 602, electronic device 500 displays representations of items with visual characteristics that are similar to indicate inclusion of the items in a particular calendar instances, and/or displays the representations differently to provide additional information and/or change the manner in which representations are presented to the user. For example, representation 662 and representation 664 optionally correspond to representation 648 and representation 650 respectively, and are therefore optionally displayed with fill patterns that are similar to or the same as each other. Additionally or alternatively, representation 660 optionally is similar to (or the same as) representation 646. Additionally or alternatively, representation 665, representation 668, and/or representation 670 optionally correspond to representation 652, representation 654, and representation 656 respectively, and therefore are optionally displayed with fill patterns that are similar to or the same as each other. Similarly to as described with reference to other views, the fourth view optionally includes a different scale of representation of days, such as the including an increase in the height of the days in the fourth view to accommodate the inclusion of more text. Additionally or alternatively, the number of days is optionally consistent across the various view. Additionally or alternatively, the number of weeks (e.g., rows of days) included in the fourth view is optionally less than in the other views.

In some embodiments, electronic device 500 progresses through the views of the user interface in a fixed order. For example, from the first to the second, the second to the third, the third to the fourth, and the like in response to a scaling up or a zooming in input, such as a pinching request. In some embodiments, the progression is fixed irrespective of a magnitude of the input (e.g., the distance traveled by contacts on a touchscreen) as described with reference to method 700. Similarly, when electronic device 500 detects a scaling down and/or a zooming out input, such as two contacts moving toward each other, electronic device 500 optionally traverses the fixed order in a direction that opposes the zooming in order (e.g., from the fourth to the third view, the third to the second view, and/or the like). In some embodiments electronic device 500 progresses the views without displaying intermediate views in accordance with a magnitude of the input, as described further with reference to method 700. For example, electronic device 500 optionally displays the second view or the fourth view of user interface 602 in response to detecting that input 604 is a second or a third magnitude (e.g., a distance of separation of the contacts).

In FIG. 6D, electronic device 500 detects selection input 661 directed to a representation of the third day (e.g., Thursday, November 4^{th}). In response to detecting the selection input, electronic device 500 optionally displays a view of the selected day, as described further with reference to method 900 and/or FIG. 8A.

FIG. 7 illustrates a flow diagram illustrating a method in which an electronic device displays a plurality of views of a representation of a calendar according to some embodiments. The method 700 is optionally performed at an electronic device and/or electronic devices such as device 100, device 300, or device 500 as described above with reference to FIGS. 1A-1B, 2-3, 4A-4B and 5A-5H. Some operations in method 700 are, optionally combined and/or order of some operations is, optionally, changed.

In some embodiments, an electronic device in communication with one or more input devices and a display generation component is configured to perform a method 700, such as electronic device 500 in communication with display generation component 504 as shown in FIG. 6A. For example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. Examples of input devices include physical buttons, knobs, handles, and/or switches of a vehicle, a touch screen, mouse (e.g., external), trackpad (optionally integrated or external), touchpad (optionally integrated or external), microphone for capturing voice commands or other audio input, remote control device (e.g., external), another electronic device (e.g., mobile device that is separate from the electronic device), a handheld device (e.g., external), a controller (e.g., external), a camera, a depth sensor, an eye tracking device, and/or a motion sensor (e.g., a hand tracking device, a hand motion sensor).

In some embodiments, while displaying, via the display generation component, a first view of a user interface for a calendar application, the electronic device displays (702) a first visual indication associated with a plurality of items corresponding to a first day of the calendar application, such as representation 606a as shown in FIG. 6A, wherein a first portion of the first visual indication is associated with one or more items included in a first calendar, such as first portion 608 as shown in FIG. 6A, and a second portion, different from the first portion, of the first visual indication is associated with one or more items included in a second calendar, different from the first calendar, such as second portion 610 as shown in FIG. 6A. For example, the electronic device optionally displays a user interface including a representation of a calendar (e.g., a Gregorian, lunar, and/or another type of a calendar) corresponding to a calendar application (e.g., stored in memory of the electronic device). As described further herein, the electronic device optionally displays representations of calendar items associated with one or more instances of calendars (e.g., a work calendar, a school calendar, a task calendar, and/or a birthday calendar) overlaying the representation of the calendar (e.g., overlaying respective days and/or times that are included in a respective view of the representation of the calendar). In some embodiments, the user interface for the calendar application—at times referred to herein as a calendar user interface—includes a plurality of representation of days corresponding to the calendar, text and/or images describing information associated the calendar (e.g., a current month, workweek, day of the week, day number, year, and/or some combination thereof). In some embodiments, a view of the calendar user interface includes the number and/or arrangement of days displayed corresponding to one or more calendars. For example, the first view of the calendar user interface optionally corresponds to a broadest view of the calendar application, optionally including a year, a month, or several weeks of calendar items. In some embodiments, while displaying the year, month, and/or several weeks of calendar items, the view of the calendar user interface additionally includes representation of some or all of the respective days included in such periods of time. In some embodiments, as described further herein, the first visual indication and/or additional or alternative visual indications are displayed at locations that are correspond to and/or are included in a representation of a day (e.g., in the first view, and/or in additional or alternative views). Displaying additional or alternative views of the calendar user interface described further herein optionally include displaying a different number of days, weeks, and/or months in the calendar user interface (e.g., fewer days, weeks, months, and/or changing display of the representation of the days, weeks, and months of the first view).

In some embodiments, the calendar user interface is associated with a plurality of different instances of calendars, such as calendar instances corresponding to the portions of representation 606a as shown in FIG. 6A. For example, the calendar application optionally is in communication with one or more servers that store and/or provide information defining a collection of calendar items, defining the days, times, durations of the items, recurrences of corresponding items, and/or some combination thereof. In such an example, the calendar user interface optionally integrates the various calendar items, from one or more instances of calendars and optionally displays visual indications of the various calendar items at corresponding days of the representation of the calendar. In some embodiments, a first calendar instance corresponding to a first calendar is associated with work-related calendar items, a second calendar instance corresponding to a second calendar is associated with a child's school schedule, and/or a third calendar instance corresponding to a third calendar is associated with various bills and/or home maintenance events and/or tasks. In some embodiments, the electronic device displays representations of calendar items corresponding to the first, second, and/or third calendar instances that overlay the representation of the calendar. For example, representation(s) of various work events are optionally displayed overlaying corresponding day(s) in the representation of the calendar, and/or representation(s) of various school holidays are optionally displayed overlaying corresponding day(s) in the representation of the calendar.

In some embodiments, the electronic device displays a first visual indication that corresponds to a plurality of items (e.g., events and/or other entries associated with a calendar as described with reference to method 900) that correspond to a day of the calendar application. For example, the visual indication is optionally an oblong graphic and/or icon, spanning some or all of a width or height of a day represented in the calendar user interface. Additionally or alternatively, the visual indication optionally includes a graphic, an icon, a shape, and image, text, and/or some combination thereof. In some embodiments, the visual indication includes a line, a bar, a circle, a square, a rectangle, and/or a composite shaping including a plurality of the aforementioned shapes. In some embodiments, the calendar user interface includes representations of a plurality of days that respectively include respective visual indications in accordance with a determination that one or more calendar items correspond to the respective day. For example, when at least one item corresponds to a day, the representation of the day is displayed including a visual indication (e.g., the first visual indication, or analogous visual indication). When there are no items that correspond to the day, the day is optionally displayed without including such a visual indication (e.g., the electronic device forgoes display of the first visual indication or analogous visual indication). It is understood that description of the first visual indication herein optionally applies to additional and/or alternative visual indications displayed corresponding to the respective days.

In some embodiments, a single visual indication is displayed overlaying and/or included in a representation of a day in the first view of the calendar user interface, such as representation 606a as shown in FIG. 6A. To indicate that a plurality of calendar items corresponding to different instances of calendars all correspond to the same day, the visual indication is optionally displayed with a plurality of portions having one or more visual characteristics distinguishing the respective portions. For example, the portions are optionally contiguous and/or non-overlapping, and are optionally displayed with a color, saturation, brightness, fill pattern, graphic, text, and/or some combination thereof that visually differentiate the various portions from each other and/or visually indicate a calendar source (e.g., a calendar instance). As a further example, the first portion of the first visual indication is optionally displayed with a red color and/or a hatching fill pattern, to indicate that the one or more first items from a first calendar correspond to a first day in the calendar user interface. The second portion of the first visual indication is optionally displayed with a blue color and/or a striped fill pattern to indicate that one or more second items from a second calendar, different from the one or more first items from the first calendar, correspond to the first day in the calendar user interface. As described further herein, the relative size (e.g., width, height, and/or some combination thereof) of the first and second portions optionally indicate a proportion of the day consumed by items from the first and/or second calendar. In some embodiments, while displaying the first view of the calendar user interface, and when a plurality of calendar items correspond to a first day, the electronic device displays a representation of the first day including only the first visual indication (e.g., a lone shape, graphic, and/or button) without displaying (e.g., forgoing display of) additional or alternative visual indications (e.g., additional lines, bars, circles, squares, rectangles, and/or composite shapes) that represent the various calendar items associated with the first day within and/or overlaying the representation of the first day. Thus, for some or all of the representation of days presented in the first view of the calendar user interface, the electronic device optionally displays only a single respective visual indication for day(s) having one or more calendar items, irrespective of the total number of calendar items that optionally correspond to the individual day(s). In some embodiments, when the items for the first day only include items from the first calendar, the electronic device displays the first visual indication with a single portion (and forgoes display of other portions indicating items from other calendars). In such an embodiment, the first visual indication is displayed with a same size, irrespective of whether one or several calendar items from one or several calendars correspond to the day. In some embodiments, the first visual indication includes additional or alternative portions, respectively corresponding to a third, fourth, fifth, and/or sixth calendar (if such calendars are associated with the calendar application and/or include items on that day).

Some embodiments are described with reference to an oblong visual indication that is displayed with color(s) spanning different portion(s) of the oblong visual indication that optionally correspond to calendars associated with items. It is understood that description of the oblong visual indication optionally applies to additional or alternative visual indications (e.g., graphics, icons, shapes, images, and/or text).

In some embodiments, while displaying the first visual indication and the first view of the user interface, the electronic device detects 704), via the one or more input devices, one or more first inputs changing a view of the user interface, such as input 604 as shown in FIG. 6A. For example, the one or more first inputs include selection of a button that corresponds to changing the view (e.g., zooming in to the calendar along a calendar view hierarchy, zooming out of the calendar along the hierarchy, and/or directly skipping to particular views in the hierarchy without displaying intervening views of the hierarchy). In some embodiments, the one or more first inputs include a voice input specifying a particular view of the calendar user interface. In some embodiments, the one or more first inputs include touch input, such as a single contact translating in a first direction (e.g., up, down, left, or right) along a trackpad, touchscreen, and/or a non-touch sensitive surface like a table that is monitored by the electronic device. In some embodiments, the touch input includes a multi finger gesture, such as touching two fingers and moving the fingers closer together or further apart relative to one another. In some embodiments, the electronic device determines a zooming in or a zooming out of the one or more first inputs based on directionality of the one or more first inputs relative to the calendar user interface. In some embodiments, the one or more first inputs include an air gesture including movement and/or contacting of one or more fingers and/or hands of a body of a user of the electronic device, such as an air pinching contacting one or more fingers, an air swiping moving of one or more fingers, an air snapping, an air closing of one or more fingers (curling the fingers), and/or an air extending of the one or more fingers (straightening the fingers). For convenience, some embodiments are described with reference to touch input including pinching of the fingers (e.g., moving the fingers closer) as zooming out of the calendar user interface hierarchy and/or touch input including separating of the fingers as zooming into the calendar user interface hierarchy.

In some embodiments, in response to detecting the one or more first inputs (706), the electronic device displays (708), via the display generation component, a second view of the user interface, different from the first view of the user interface, such as the view of user interface 602 as shown in FIG. 6B. For example, in accordance with a determination that the touch input indicates a zoom-in operation while the first view is a month view that includes the first visual indication, the electronic device optionally ceases display of the first view and optionally initiates display of a second view that also includes a month's worth of calendar items, but does not include the first visual indication (as described further below). In some embodiments, displaying the second, zoomed in view includes changing of a dimension of a representation of days and/or weeks. For example, in the first view, respective days are optionally displayed with first rectangles, ovals, and/or other shapes having first sizes and/or spatial profiles relative to the calendar user interface. In the second view, the respective days are optionally displayed with second rectangles, ovals, and/or other shapes having second sizes and/or spatial profiles. In some embodiments, when transitioning from the first view to the second view, the electronic device maintains display of one or more portions of a representation of a day or week in place, such as a midpoint of rectangle representing a day, an upper or lower edge of the rectangle, a lateral edge, and/or some combination thereof. The electronic device optionally displays an animation transitioning from the first to the second view, such as maintaining the width and/or a position of an upper edge of days in the calendar user interface, and optionally extending the height (e.g., the length of the lateral edges of the day and/or the location of the lower edge of the day), thus increasing the region of the calendar user interface consumed by respective days. In some embodiments, displaying the second view of the calendar user interface includes displaying fewer representation of days, such as displaying representations of one, two, and/or three weeks of days, instead of representations of a month of days presented while displaying the first view of the calendar user interface. In some embodiments, displaying the second view includes displaying a representation of a single day, or includes fewer representations of days than included in representations of days of a week. In some embodiments, transitioning from displaying the second view to displaying the first view of the calendar user interface includes displaying a greater number of a representations of days than displayed while presenting the second view of the calendar user interface. For example, the electronic device optionally displays a week of representations of days while presenting the second view of the user interface, and in response to input(s) requesting display of the first view of the user interface, optionally displays several weeks and/or a month of representations of days corresponding to the first view of the calendar user interface.

In some embodiments, in response to detecting the one or more first inputs (706), the electronic device displays (710), via the display generation component, a plurality of second visual indications, different from the first visual indication, wherein a respective first visual indication of the plurality of second visual indications corresponds to the first portion of the first visual indication and is associated with the one or more items included in the first calendar, and wherein a respective second visual indication of the plurality of second visual indications corresponds to the second portion of the first visual indication and is associated with the one or more items included in the second calendar, such as representation 620 as shown in FIG. 6B and/or such as representation 622 as shown in FIG. 6B. For example, the electronic device optionally ceases display of the first visual indication and/or initiates display of the plurality of second visual indications in response to the input. In some embodiments, the second one or more visual indications respectively correspond to the portions of the first visual indication. For example, the respective first visual indication of the plurality of second visual indications optionally is an oblong indicator having first visual characteristic(s) that correspond to the first portion of the first visual indication (e.g., the first visual characteristic(s) are similar to, based upon, and/or the same as those of the first portion). For example, the first visual indication included in the first view of the calendar user interface is optionally a same shape as the first visual indication of the plurality of second visual indications, additionally or alternatively sharing one or more other visual characteristics (e.g., borders, color of the borders, fill patterns, and/or length of one or more dimensions). In some embodiments, the width of the first visual indication displayed in the first view of the calendar user interface is the same as respective widths of respective visual indications included in the second visual indications. Thus, the respective first visual indication optionally corresponds to items from the first calendar. Similarly, the respective second visual indication optionally is another oblong indicator having visual characteristic(s) that correspond to the second portion of the first visual indication (e.g., the second visual characteristic(s) are similar to, based upon, and/or the same as those of the second portion). Thus, the respective second visual indication optionally corresponds to items from the second calendar. It is understood that additional similarities between the corresponding portions of the first visual indication and corresponding respective portions of respective visual indications of the one or more second visual indications are contemplated, such as similar or the same fill pattern, color outline, inclusion of a graphic, text, inclusion of a simulated glowing effect displayed emanating from edges of the visual indications, saturation, hue, a brightness, and/or some combination thereof based on the corresponding indications corresponding to the same calendars.

In some embodiments, the plurality of second visual indications are displayed corresponding to a same day as the first visual indication (e.g., contained within a rectangular or elliptical boundary, optionally displayed or not displayed, corresponding to a first day in the calendar). In some embodiments, the plurality of second visual indications are displayed with respective positions within a given representation of a day corresponding to a chronological order associated with items that correspond to respective visual indications. For example, in accordance with a determination that one or more items associated with the first calendar occurs at a time of day that precedes an earliest of one or more items associated with the second calendar, the respective first visual indication is optionally displayed in a first position relative to a day in the calendar user interface (e.g., before the respective second visual indication relative to the day in the calendar user interface). In accordance with a determination that an earliest of the one or more items associated with the second calendar precedes the one or more first items associated with the second calendar, the respective second visual indication is optionally displayed in the first position (e.g., before the respective first visual indication relative to the day in the calendar user interface). In some embodiments, a spatial arrangement of the respective portions included in the first visual indication that are presented while displaying the first view of the calendar user interface corresponds to a spatial arrangement of respective visual indications included in the plurality of second visual indications that are presented while displaying the second view of the calendar user interface. For example, the first portion of the first visual indication included in the first representation of the first day optionally corresponds to calendar items from a first calendar, and optionally consumes a leftmost portion of the first visual indication. Additionally, the second portion of the first visual indication optionally corresponds to calendar items from a second calendar, and optionally consumes a rightmost portion of the visual indication (e.g., the first and second portions are contiguous and non-overlapping). In some embodiments, when displaying the second view of the calendar user interface, the electronic device updates display of the first representation of the first day such that the first of the plurality of second visual indications (e.g., that corresponds to the first calendar) is displayed above a second of the plurality of second visual indications. It is understood that the relative arrangement of the plurality of second visual indications is optionally based upon (e.g., corresponds to) the chronological order of respective calendar items corresponding to respective calendars for additional and/or alternative calendars. For example, the electronic device optionally displays a respective visual indication of the second plurality of visual indications at a respective position within a left-to-right or top-to-bottom order based upon the time of the earliest calendar item that is included in each of the respective calendars (e.g., the topmost or leftmost visual indications corresponding to the earliest of all calendar items, and/or the bottommost or rightmost visual indications corresponding to the latest of all the calendar items). Thus, the visual indication of the plurality of second visual indications that has a relatively earlier item of a day is optionally displayed above, to the left of, to the right of, and/or other visual indication(s) of the plurality of second visual indications. Displaying the first visual indication when displaying the first view and displaying a plurality of second visual indications when displaying the second view provides visual consistency and indicates a relationship between visual indications displayed across different views of the calendar, thus reducing visual clutter and presenting pertinent calendar information while displaying the first view of the calendar user interface.

In some embodiments, the first visual indication indicates a density of the one or more items included in the first calendar and the second calendar, such as a height and/or width of representation 606a in FIG. 6A and/or representation 892 in FIG. 8R. For example, one or more visual characteristics of the first visual indication are optionally varied based upon the density (e.g., as described further herein) of the one or more items. As an example, the electronic device optionally displays the first visual indication with a first scale (e.g., height, width, and/or both) in accordance with a determination that a first quantity of items that correspond to a day managed by the calendar application and corresponds to the first visual indication. In accordance with a determination that a second quantity of items corresponds to the day, the electronic device optionally forgoes display of the first visual indication with the first scale and optionally displays the first visual indication with a second scale, different from the first scale.

In some embodiments, the density of the one or more item includes a relative number of calendar items that begin, are included in, and/or end at times that are included in a period of time (e.g., some or all) of a day represented in the calendar application, such as the first day of the calendar application described with reference to method 700. It is understood that description of embodiments referencing the quantity of items included in a day optionally apply to portions of the day, such as the quantity of items included in the workday (e.g., 8 AM to 5 PM, 9 Am to 6 PM, and/or 6 AM to 6 PM). In some embodiments, the density of items is associated with the relative start time of items, the relative end time of items, some combination thereof, in addition to or in the alternative to the raw quantity of the items. For example, in accordance with a determination that a first quantity of items (e.g., one, two, three, or four) start at times within ten minutes of one another, the density is optionally determined to be a first density (e.g., by the electronic device, and/or one or more other computing systems such as servers in communication with the electronic device). In accordance with a determination that a second quantity of items (e.g., two, three, four, or five) items start at times within ten minutes of one another, the density is optionally determined to be a second density. It is understood that density of calendar items that correspond to a period of time, such as some or all of the day, is optionally determined in accordance with a combination of one or more of the embodiments relating to calendar item density described herein.

In some embodiments, the scale of the visual indication relatively increases when a greater density of items corresponds to the day and relatively decreases when a lesser density of items corresponds to the day. For example, in response to detecting one or more inputs removing a first calendar item from the day, the electronic device optionally decreases the height and/or width of the first visual indication. Additionally or alternatively, the electronic device optionally changes one or more other visual characteristics of the first visual indication. For example, the electronic device optionally changes a saturation of color(s) included in the first visual indication, optionally changes an opacity of the first visual indication, and/or changes the opacity of a filling pattern (e.g., a cross-hatched pattern, a striped pattern, and/or a dotted pattern) in accordance with changes to calendar item density corresponding to a period of time (e.g., the first day, another day, and/or a subset of the first day).

In some embodiments, one or more respective first visual characteristics of a respective first portion of the visual indication change in accordance with changes to items that correspond to a respective first calendar. For example, in accordance with a determination that the electronic device detects input(s) removing an item that fall on the first day and are associated with the first calendar (e.g., as described with reference to method 700), the electronic device optionally decreases the width of the first portion of the first visual indication, and/or optionally forgoes changing (e.g., maintains) the width of the second of the first visual indication that is associated with the second calendar. In response to detecting input(s) adding an item to the first calendar, and when the added item falls on the first day, the electronic device optionally increases the width of the first portion of the first visual indication, and/or optionally forgoes changing (e.g., maintains) the width of the second portion of the first visual indication. It understood that the electronic device optionally changes the width of the second portion of the first visual indication in response to detecting input(s) adding the item to the second calendar, optionally instead of the first calendar, in a manner similar to or the same as described with reference to the first calendar (e.g., changing the width of the second portion of the first visual indication while forgoing changes to the width of the first portion of the first visual indication).

In some embodiments, the respective first visual indication does not indicate the density of the one or more items included in the first calendar and the second calendar, such as representation 620 and/or representation 622 as shown in FIG. 6B displayed with a same width. For example, in response to detecting input(s) adding and/or removing an item from the first and/or second calendar, and while presenting the second view of the user interface for the calendar application, the electronic device optionally forgoes changing one or more characteristics of some or all of the plurality of second visual indications (e.g., the respective first and/or respective second visual indication described with reference to method 700). As an example, the electronic device optionally maintains the size of the respective first and/or the respective second visual indication in accordance with a determination that the density of calendar items corresponding to the respective visual indications changes. Thus, one or more first visual characteristics of the first visual indication change in accordance with calendar item density, and/or one or more visual characteristics of the plurality of second visual indications that are similar to or the same as the one or more first visual characteristics optionally do change in accordance with the calendar item density. Indicating density of the one or more items included in the first and/or second calendar in the first view, and not in the second view, reduces visual clutter of items represented in the first view and/or improves visual consistency of items represented in the second view, thus user input(s) required to preview the density of the calendar items and/or preview a more granular representation of the calendar items, thereby reducing processing required to perform operation(s) in accordance with the user input(s).

In some embodiments, a scale of the first visual indication relative to the user interface corresponds to a density of the one or items included in the first calendar and a density of the one or more items included in the second calendar, such as the width of representation 606a as shown in FIG. 6A. For example, as described with reference to the density of the one or more items included in the first view of the user interface, the electronic device optionally changes the height, width, and/or some combination thereof in accordance with the density of items that correspond to a respective day managed by the calendar application such as the first day. Indicating the density of the one or more items with a scale of the first visual indication improves visual clarity of busy and/or relatively less busy days, thus reducing cognitive load of a user of the electronic device.

In some embodiments, a quantity of the plurality of second visual indications is based upon a number of the one or more items included in the first calendar and the second calendar, such as the quantity of representations corresponding to representations 620, 622, and/or 624 as shown in FIG. 6B. For example, in accordance with a determination that a first item corresponding to the first calendar corresponds to the first day, the electronic device optionally displays a corresponding visual representation included in the second plurality of representation that fall on (e.g., overlay and/or are displayed adjacent to a representation of) the first day. In accordance with a determination that the first item corresponds to a second day, different from the first, the electronic device optionally forgoes display of the visual representation overlaying and/or adjacent to the representation of the first day, and optionally displays the visual representation overlaying and/or adjacent to the representation of the second day. In some embodiments, the electronic device displays a representation of an item included in the plurality of second visual indications-irrespective of the corresponding calendar-when the item is added to a respective instance of a calendar managed by the calendar application (e.g., added to the first and/or second calendar). Displaying one or more second visual indications in accordance with a number of the one or more items included in an instance of a calendar managed by the calendar application visually indicates that a respective item is managed by the calendar application, thus reducing additional user input required to view the number of items that are managed, thereby reducing power consumption of the electronic device required to perform operations in accordance with the additional user input.

In some embodiments, displaying the first view of the user interface for the calendar application including the first visual indication includes, in accordance with a determination that the one or more items included in the first calendar correspond to a first density relative to the first day, displaying the first portion of the first visual indication with one or more first visual characteristics having one or more first values, such as a density of items associated with representation 606a and the corresponding scale with which representation 606a is displayed in FIG. 6A. For example, as described with reference to method 700 and/or described with reference to the density of the one or more items, the electronic device optionally varies one or more visual characteristics of the first portion of the first visual indication in accordance with the density of items relative to the first day. As described further herein, such one or more visual characteristics optionally include the scale, saturation, and/or opacity of the first portion of the first visual indication. In some embodiments, when the one or more items associated with a respective calendar correspond to a first density relative to the first day, the one or more visual characteristics are assigned one or more first values by the electronic device. In some embodiments, some visual characteristic(s) of the first portion of the first visual indication are independent of the density of the one or more calendar items. For example, the electronic device optionally maintains the color, saturation, and/or a fill pattern of the first portion of the first visual indication in response to detecting one or more inputs changing the density (e.g., changing the times and/or days) of items associated with the first calendar, and optionally changes other visual characteristic(s) such as size, brightness, and/or opacity of the fill pattern in accordance with the density of the one or more items included in the first calendar that correspond to the first day. As an example, when the density corresponds to a first density, the size, brightness, and/or opacity corresponds to respective first levels of size, brightness, and/or opacity. It is understood that similar description applies to portion(s) of other portion(s) of the first visual indication, such as the second portion of the second visual indication that is associated with the second calendar. For example, the electronic device optionally maintains the color, saturation, and/or a fill pattern of the second portion of the first visual indication in response to detecting one or more inputs changing the density (e.g., changing the times and/or days) of items associated with the second calendar, and optionally changes other visual characteristic(s) such as size, brightness, and/or opacity of the fill pattern in accordance with the density of the one or more items included in the second calendar that correspond to the first day.

In some embodiments, displaying the first view of the user interface for the calendar application including the first visual indication includes, in accordance with a determination that the one or more items included in the first calendar correspond to a second density relative to the first day, different from the first density, displaying the first portion of the first visual indication with the one or more first visual characteristics having one or more second values, different from the one or more first values, such as a density of items associated with representation 606b and the corresponding scale with which representation 606b is displayed in FIG. 6A. For example, in accordance with a determination the density is the second density, the electronic device optionally changes the scale, brightness, and/or opacity of the first portion of the visual indication from the respective first levels of size, brightness, and/or opacity from first values to respective second values after and/or in response to detecting input(s) adding an event—and thereby increasing density—of the one or more items relative to the first day. Displaying the portion(s) of the first visual indication with values of visual characteristic in accordance with the density of items relative to a respective day reduces visual clutter, thereby reducing cognitive load required by a user of the electronic device examining the calendar user interface for calendar item density of the respective day.

In some embodiments, displaying the first portion of the first visual indication includes displaying the first portion with a first visual characteristic having a first value, independently of respective densities of the one or more items included in the first calendar that correspond to the first day and independently of respective densities of the one or more items included in the second calendar that correspond to the second day, such as the fill pattern of first portion 608 as shown in FIG. 6A. In some embodiments the electronic device displays portion(s) of the first visual indication with one or more visual characteristics as described above and/or herein. For example, the electronic device optionally displays the first portion of the first visual indication with a first color and optionally displays the second portion of the first visual indication with a second color, different from the first color. In such an example, the color of respective portions of the first visual indication are optionally independent of calendar item density (e.g., colors of portions of the first visual indicated are maintained in response to detecting input(s) changing the calendar item density). In some embodiments, different visual indications included in the first view of the user interface for the calendar application (e.g., corresponding to respective days managed by the calendar application) include respective portions which correspond to the first and/or second calendar. In some embodiments, the respective portions are displayed with visual characteristic(s) having value(s) that are similar to or the same as the values of the first visual characteristic to indicate. Thus, in the first view, values of visual characteristics of portions of visual indications that correspond to respective days optionally indicate the existence of items that correspond to different calendars.

In some embodiments, displaying the plurality of second visual indications and the second view of the user interface includes displaying the respective first visual indication with the first visual characteristic having a respective first value based upon the first value (e.g., the same as the first value), such as the fill pattern of second portion 610 as shown in FIG. 6A. For example, the electronic device optionally displays the first portion of the first visual indication included in the first view and the respective first visual indication included in the second view with a same color, brightness, saturation, and/or fill pattern. In some embodiments, each portion of the first visual indication and each of the plurality of second visual indications are displayed with a visual characteristic having a value that is unique to, and thereby indicates an association with, a respective calendar. For example, the electronic device optionally displays the second portion of the first visual indication with a different color, brightness, saturation, and/or fill pattern than the first portion of the first visual indication; the respective second visual indication optionally displayed with the color, brightness, saturation, and/or fill pattern of the second portion of the first visual indication. In some embodiments, such values of visual characteristics are consistent across different views of the calendar user interface (e.g., a third and/or fourth view of the user interface), while other aspects of representation of calendar items change. For example, various views of the calendar user interface optionally indicate that a representation of one or more items belongs to a respective calendar based upon the color, brightness, and/or saturation of various icon(s) (e.g., included in) associated the corresponding representation. Displaying portions of the first visual indication with a value of a visual characteristic and displaying respective visual indications of the plurality of second visual indications provides visual consistency between representations of items that correspond to particular calendars, thus reducing user input required to discern a relationship between representation included in views of the calendar user interface, thereby reducing processing required to perform operations in accordance with such user input.

In some embodiments, displaying the second view of the user interface and displaying the plurality of second visual indications in response to detecting the one or more inputs, such as displaying the view of user interface 602 as shown in FIG. 6C including representation 648 and/or representation 646, includes, in accordance with a determination that a respective item included in the one or more items included in the first calendar corresponds to a plurality of days including the first day of the calendar application, such as the plurality of days that representation 646 spans as shown in FIG. 6C, displaying the respective first visual indication occupying a first region of the second view of the calendar user interface corresponding to the first day of the calendar application and occupying a second region corresponding to a second day of the calendar application, different from the first day, wherein the first region and the second region are contiguous (and/or adjacent) regions of the second view of the calendar user interface, such as the regions of user interface 602 across which representation 646 spans and/or overlays, as shown in FIG. 6C. For example, one or more dimensions of respective representations included in the plurality of second visual indications optionally indicate that a respective item associated with a calendar extend across one or more representation of days. As an example, the electronic device optionally displays an oblong visual indication of a first calendar item such as a work trip, a vacation, and/or an out-of-the-office period that extends from a representation of the first day to a representation of a second day, different from the first day. The oblong visual indication optionally spans across a number of representation of days corresponding to the duration of the respective item, such as across a plurality of representations of days of a vacation. In some embodiments, the regions of the user interface are contiguous, such that the visual indication extends across several representation of days. In some embodiments, the user interface are non-contiguous, and the position of a first portion of the oblong visual indication relative to the first day corresponds to the position of a second, non-contiguous portion of the oblong visual indicate relative to a representation of the second day. For example, the respective visual indication optionally is displayed at a first height relative to a representation of a Saturday included in a first row of days represented in the calendar user interface, and the respective visual indication is optionally displayed at the first height relative to a representation of Sunday included in a second row of days, due to the duration of the corresponding item spanning from Saturday of a first week through Sunday of the next week. Displaying visual indications included in the second view of the user interface for the calendar application occupying contiguous and/or adjacent regions of the user interface optionally indicates the continuity of corresponding calendar item(s), thus reducing user input required to investigate the duration of the calendar item(s), thereby reducing processing required to perform operations related to the user input.

In some embodiments, displaying the first visual indication while displaying the first view of the user interface for the calendar application includes, such as representation 606b as shown in FIG. 6A, in accordance with the determination that the respective item included in the one or more items included in the first calendar corresponds to the plurality of days including the first day of the calendar application, such as a calendar item corresponding to representation 646 as shown in FIG. 6C and/or corresponding to representations 606b, 606c, and/or 606d as shown in FIG. 6A, displaying the first portion of the first visual indication occupying a first region of the first view of the calendar user interface corresponding to the first day of the calendar application and displaying a second visual indication that additionally corresponds to the respective item, different from the first visual indication, occupying a second region corresponding to a second day of the first view of the calendar application, different from the first day, such as representation 606b displayed at a first region of user interface 602 and such as representation 606c displayed at a second region of user interface 602 as shown in FIG. 6A. For example, when displaying the first view of the calendar user interface, the electronic device optionally displays separate and/or discrete visual indications corresponding to representation of days associated with a respective item to represent that the respective item spans a plurality of days. In response to detecting input changing the view to be the second view, the electronic device optionally displays a monolithic visual indication that spans contiguous and/or adjacent regions of the user interface (e.g., spanning the representations of days corresponding to the respective item). Thus, the first region of the first view the user interface is optionally non-contiguous with the second region of the first view of the user interface. For example, when an item spans from the first day described with reference to method 700 to a second day, the electronic device optionally displays the first portion of the first visual indication occupying a portion of a day represented in the first view of the user interface for the calendar application, and displays another portion of another visual indication corresponds to another day in the first view, without displaying any indication of such an item that visually extends outside of one day and/or through, into or over multiple days. In such an example, the first and the second day are optionally displayed in a same row and/or column of a representation of the calendar, but the representation of the item are not contiguous with one another. Displaying a non-contiguous and/or non-adjacent representation of an item allows the electronic device to present an aggregate representation of items corresponding to various calendars, thus reducing visual clutter and thereby reducing the user's cognitive load.

In some embodiments, while displaying the second view of the user interface, such as the view of user interface 602 as shown in FIG. 6B, the electronic device detects, via the one or more input devices, one or more second inputs changing the view of the user interface, such as input 644 as shown in FIG. 6B. For example, the one or more second inputs optionally include or correspond to a scaling input directed to the user interface for the calendar application. The one or more second inputs optionally have one or more characteristics similar to or the same as described with reference method 700 relating to the one or more inputs changing the view of the user interface from the first view to the second view. For example, the one or more second inputs optionally include a voice command and/or one or more optionally concurrent touch inputs (e.g., two contacts on a touchscreen moving toward or away from each other, a swiping up, a swiping down, and/or some combination of those touch inputs), and/or a selecting of a physical or virtual button.

In some embodiments, in response to detecting the one or more second inputs the electronic device concurrently displays, via the display generation component, a third view of the user interface, different from the second view and different from the first view of the user interface, such as the view of user interface 602 as shown in FIG. 6C. For example, the third view of the user interface for the calendar application optionally includes one or more visual indications corresponding to various calendar items that are represented differently than how other indications included in the first and/or second views of the user interface are represented. In some embodiments, the plurality of third visual indications are displayed concurrent with information associated with the visual representation of the various calendar items.

In some embodiments, in response to detecting the one or more second inputs, the electronic device displays, via the display generation component, a plurality of third visual indications, different from the plurality of second visual indications and different from the first visual indication, such as representation 648 and/or representation 650 as shown in FIG. 6C, wherein a respective first visual indication of the plurality of third visual indications corresponds to the first portion of the first visual indication, and wherein a respective second visual indication of the plurality of third visual indications corresponds to the second portion of the first visual indication, such as the correspondence between representation 648 as shown in FIG. 6C and representation 622 as shown in FIG. 6C. For example, the third visual indications have one or more characteristics similar to or the same one or more characteristics of the first visual indication and/or the plurality of second visual indications. In some embodiments, the plurality of third visual indications has one or more characteristics that are different from the first visual indication and/or the plurality of second visual indications. For example, respective visual indications included in the third view optionally include additional information such as text, pictures, and/or graphics that were not included in visual indications corresponding to same calendar items that are presented in the first and/or second views.

In some embodiments, In some embodiments, in response to detecting the one or more second inputs, the electronic device displays, via the display generation component, respective information corresponding to respective items included in the one or more items included in the first calendar, such as text included in representation 648 as shown in FIG. 6C, wherein the respective information is different from the plurality of third visual indications, wherein the respective information is not included in the first view of the user interface and is not included in the second view of the user interface, such as the lack of such text included in representation 622 as shown in FIG. 6B. As one example, a representation of a calendar item in the second view optionally includes an icon having a rectangular shape. In response to detecting the one or more second inputs, the electronic device optionally changes the shape of the representation of the item (e.g., to a square, circle, or oval) and optionally displays text that corresponds to a title of the item that is not displayed when the electronic device displays the first and/or the second view of the user interface (e.g., when the first and/or second views include a respective representation that is associated with the same calendar item). In the first view, for example, the first portion of the first visual indication optionally is a colored segment that has a first color, and optionally does not include textual information. In the second view, the respective first visual indication optionally is the same color, and corresponds to a same calendar item. In the third view, a first representation of the plurality of third visual indications optionally is displayed with an icon that is the same color as the aforementioned visual indications, and additionally includes a time and/or part or all of a title of the item. In some embodiments, the information included in the third view corresponding to respective calendar items is a portion of more extensive information included in a more-detailed view (e.g., a fourth view) of the user interface for the calendar application. Displaying a third view of the calendar user interface including information that is not included in the first and/or second views of the user interface reduces the amount of user input required to view such information, thereby reducing power consumption required to perform operations associated with the user input.

In some embodiments, the one or more inputs include a request to change the user interface for the calendar application by a first amount, such as a magnitude (e.g., distance, velocity, and/or acceleration) of input 604 as shown in FIG. 6A. For example, the electronic device optionally detects one or more inputs requesting a scaling of the user interface. In some embodiments, the scaling of the user interface is independent of the amount of scaling requested in accordance with the one or more inputs.

In some embodiments, while displaying the first view of the user interface for the calendar application, the electronic device detects, via the one or more input devices, one or more second inputs, different from the one or more first inputs, wherein the one or more second inputs include a request to change the user interface for the calendar application by a second amount, greater than the first amount, such as a magnitude of input 604 as shown in FIG. 6A that is potentially greater than first amount. For example, the one or more second inputs optionally have one or more characteristics similar to or the same as the one or more characteristics of the one or more inputs described with reference to method 700, and optionally have one or more characteristics that are different from one or more characteristics of the one or more inputs described with reference to method 700. As an example, both one or more inputs optionally include a similar or same gesture of touch input and/or modality of input, such as both including a swiping up by a respective distance, swiping down by a respective second distance, and/or a movement of two contacts on a touchscreen toward or away from one another. In some embodiments, the amount of distance traveled by the contact(s) swiping up, down, toward, and/or away from each other differs. For example, the first amount optionally corresponds to a first magnitude of change in distance contacts moving away from each other, and the second amount optionally corresponds to a second magnitude of change in distance of the contacts moving away from each other (e.g., the first amount and first magnitude being greater than or less than the second amount and the second magnitude). Additionally or alternatively, the first amount optionally corresponds to a swiping of a contact upward by a first distance, and the second amount optionally corresponds to swiping of the contact upward by a second distance that is greater than the first distance.

In some embodiments, in response to detecting the one or more second inputs the electronic device displays, via the display generation component, the second view of the user interface, different from the first view of the user interface, such as the view of user interface 602 as shown in FIG. 6B. In some embodiments, in response to detecting the one or more second inputs the electronic device displays, via the display generation component, the plurality of second visual indications, different from the first visual indication, including the respective first visual indication of the plurality of second visual indications and the respective second visual indication of the plurality of second visual indications, such as representations 620, 622, and/or 624 as shown in FIG. 6B. For example, the electronic device optionally changes the view of the user interface of the calendar application from the first view to the second view in response to detecting the one or more inputs or the second one or more inputs despite a difference in the amount of scaling requested by the respective one or more inputs. Thus, the electronic device optionally forgoes changing of the view from the first view to a third view no matter how large the magnitude of the input is (e.g., because the electronic device only allows for one-by-one cycling through views of the calendar user interface). Described an additional way, the various user inputs including requesting of scaling of the user interface for the calendar application are optionally operative to iterate through a sequence of views of the user interface in a first direction along the sequence, such as from the first view to the second view. Additionally or alternatively, while displaying the second view, and in response to detecting one or more third inputs, the electronic device optionally displays the third view of the user interface independently of the amount of scaling requested by the one or more third inputs.

In some embodiments, in response to detecting one or more inputs scaling the user interface for the calendar application in another direction, the electronic device changes the view of the user interface to iterate in a second direction along the sequence of views of the user interface, different from the first direction. For example, the one or more inputs described with reference to method 700 and/or the one or more second inputs optionally include a moving apart of two contacts on a touch screen and/or a swiping upward of a single contact, enlarging representation of days in the user interface and/or initiating display of information that was not previously displayed (e.g., when transitioning from the second view to the third view of the user interface, described above). In response to detecting one or more fourth inputs, such as a moving of the contacts toward each other on the touch screen and/or a swiping down of the single contact, the electronic device optionally changes the view of the user interface for the calendar application from the second view to the first view of the user interface, from the third view to the second view of the user interface, and the like. Thus, the electronic device optionally cycles through the second of views in a direction based upon a direction of movement of touch input. It is understood that such description similarly applies to movement of portions of the user's body, such as movement of fingers and/or hands closer together being detected and iterating through the sequence in a first direction, and movement of the fingers and/or hands moving further apart being detected and iterating through the sequence in a second, opposing direction. Changing a view of the user interface in response to one or more inputs from a first view to a second view when such one or more inputs indicate a first or indicate a second amount of change to the user interface reduces the likelihood the user erroneously causes display of an unintended view of the user interface, thus reducing user input required to display the intended view of the user interface, thereby reducing processing required to perform operations related to the user input.

In some embodiments, the one or more inputs include a request to change the user interface for the calendar application by a first amount, such as a magnitude (e.g., distance, velocity, and/or acceleration) of input 604 as shown in FIG. 6A. For example, the one or more inputs and/or the first amount have one or more characteristics similar to or the same as described with reference to method 700 and/or with reference to displaying the second view of the user interface in response to detecting one or more second inputs. In some embodiments, because calendar application permits skipping between views of the user interface for the calendar application, the electronic device changes from the first view to the third view, from the third view to the first view, and/or from the second view to a fourth view of the user interface without displaying intermediate views of the user interface (e.g., without displaying the second view, when transitioning from the first to the third view).

In some embodiments, while displaying the first view of the user interface for the calendar application, the electronic device detects, via the one or more input devices, one or more second inputs, different from the one or more first inputs, wherein the one or more second inputs include a request to change the user interface for the calendar application by a second amount, greater than the first amount, such as a magnitude of input 604 as shown in FIG. 6A that is potentially greater than first amount. For example, the one or more second inputs optionally have one or more characteristics similar to or the same those described above.

In some embodiments, in response to detecting the one or more second inputs the electronic device displays, via the display generation component, a third view of the user interface, different from the first view of the user interface and different from the second view of the user interface, such as the view of user interface 602 as shown in FIG. 6C that is different from the view of user interface 602 as shown in FIG. 6B. For example, the third view of the user interface optionally has one or more characteristics similar to or the same those described herein. In some embodiments, the electronic device changes the view of the user interface for the calendar application in accordance with the requested amount of change of the user interface. For example, the electronic device optionally detects a moving of two concurrent contacts on a touch screen and/or a touch-sensitive device toward each other. In response to the detecting of the movement of the contacts, the electronic device optionally initiates changing of the view of the user interface from the first view to the third view, optionally forgoing display of the second view of the user interface. Thus, the electronic device optionally omits and/or skips display of a view of the user interface for the calendar application (e.g., the second view) when the amount of change is the second amount of change (e.g., the change in distance of the contacts relative to each other). Thus, in some embodiments, the electronic device progresses through more views of the calendar user interface the larger the magnitude of the input is, and fewer views the smaller the magnitude of the input is.

In some embodiments, in response to detecting the one or more second inputs the electronic device displays, via the display generation component, a plurality of third visual indications, different from the first visual indication and different from the plurality of second visual indications, such as the representations 648 and/or 650 as shown in FIG. 6C, wherein a respective first visual indication of the plurality of third visual indications corresponds to the respective first visual indication of the plurality of second visual indications, and a respective second visual indication of the plurality of third visual indications corresponds to the respective first visual indication of the plurality of second visual indications, wherein respective information included in the third view of the user interface corresponding to respective items included in the one or more items included in the first calendar is not included in the first view of the user interface and is not included in the second view of the user interface, such as the information included in representation 648 and/or 650 as shown in FIG. 6C. For example the plurality of third visual indications and/or the respective information included in the third view of the user interface have one or more characteristics similar to or the same as described herein with reference to similar or the same terms when describing the third view of the user interface. In some embodiments, the information included in the third view of the user interface and not in the first and/or second view of the user interface includes text describing a title of a calendar item in its entirety. In some embodiments, an icon with a visual characteristic similar to or the same as described with reference to visual characteristics of representations of calendar items herein is displayed in the third view, such as an icon having a same color having a first shape in the third view. In such an embodiment, the electronic device optionally displays an icon representative of the same calendar time having the same color but having a different shape in the second view. In some embodiments, the respective information displayed corresponding to, such as near and/or adjacent to, the representation of the calendar item in the third view includes a name and/or time associated with the calendar item (e.g., “Coffee at 10:00 AM,” “Pick up dry cleaning at 4:00 PM,” and/or “Recital”). Displaying the third view of the user interface in response to detecting one or more second inputs corresponding to a request to change the user interface by a second amount reduces user inputs required to discretely sequence through views of the user interface, thus reducing user input and thereby reducing power consumption of the electronic device required to perform operations in response to the user input.

In some embodiments, the one or more inputs are one or more scaling inputs, such as the movement of contacts included in input 604 as shown in FIG. 6A. For example, as described herein, the one or more inputs optionally are or optionally include movement of one or more contacts on a touch-sensitive surface such as a touchscreen or trackpad. In some embodiments, the one or more scaling inputs include movement of one or more fingers and/or a plurality of hands of a user of the electronic device toward or away from each other. As described further herein, scaling the user interface optionally includes changing between views of the user interface, such as from the first view to the second view, from the first view to the third view, from the third view to the first view, and/or other combinations between various views. In some embodiments, the amount of scaling of the user interface requested by the one or more scaling inputs is based upon a direction and/or magnitude of movement of the contacts and/or the portions of the user's body. For example, the electronic device optionally determines that the one or more scaling inputs correspond to increasing a scale of the user interface for the calendar user interface when contacts and/or portions of the user's body move toward each other, and optionally determines that the one or more scaling inputs correspond to decreasing the scale of the user interface when the contacts and/or portions of the user's body move away from each other. In some embodiments, the scaling input(s) are based upon single contact and/or are determined based upon movement of a single body part, such as movement of the contact vertically or laterally with respect to the user interface, and/or movement of a hand or finger in a depth, height, and/or lateral direction relative to the user's three-dimensional environment. Thus, the electronic device optionally forgoes scaling of the user interface in response to detecting other movements of contact(s) and/or air gesture(s) while detecting a prior contact and/or air gesture. In some embodiments, when the scaling input(s) are based upon movement of the user's body, movement of the portion of the user's body is used to scale the user interface when an air gesture is detected and/or maintained, and/or scaling of the user interface is forgone when the air gesture is ceased and/or not detected. For example, when the electronic device detects an air pinch including contact between fingers of a user's hand (and/or a second air pinch performed by a second hand of the user), the electronic device optionally detects movement of the user's hand(s) and optionally translates that movement to correspond to a request to scale the user interface. In accordance with a determination that the one or more air pinches are ceased and/or are never detected, the electronic device optionally forgoes scaling of the user interface based upon respective movement of portions of the user's body. In some embodiments, when not displaying a user interface of the calendar application, in response to detecting the air pinch and/or movement of the air pinch (and/or detecting other air gesture(s)), the electronic device changes a scale of currently displayed content. For example, the electronic device optionally detects a scaling air gesture that is the same as the air gesture that changes the scale of the calendar user interface, and optionally scales (e.g., increases and/or decreases) an image, a video, text, and/or other portions of a user interface that are different from and/or displayed separately from the user interface for the calendar application. Scaling the user interface in accordance with one or more scaling inputs reduces power required to detect more elaborate sequences of inputs required to scale the user interface.

In some embodiments, displaying the first view of the calendar user interface includes displaying a first quantity of representations of days along a first dimension of the user interface and includes displaying a second quantity of representations of days along a second dimension of the user interface, different from the first dimension, such as the quantities of days included in a first and a second dimension of a representation of a calendar included in user interface 602 as shown in FIG. 6A.

In some embodiments, displaying the second view of the calendar user interface includes displaying the first quantity of representations of days along the first dimension of the user interface and includes displaying a third quantity of representations of days, different from the second quantity, along the second dimension of the user interface, different from the first dimension, as the quantities of days included in a first and a second dimension of a representation of a calendar included in user interface 602 as shown in FIG. 6C. For example, the arrangement of days, weeks, and/or months included in the representation of the calendar is optionally different (or the same) between various views of the user interface for the calendar application. For example, the representation of the calendar in the first view that optionally includes a representation of days of a month, and optionally includes a first row (e.g., the first dimension) of days forming a week of days. In response to detecting the input(s) changing from the first view to the second view (and/or to the third view), the electronic device optionally maintains the quantity of representations of days in the first row and/or other rows (e.g., the first week and/or other weeks) included in the representation of the calendar. In some embodiments, in response to detecting the input(s) changing from the first view to the second view (and/or to the third view), the electronic device changes the quantity of representations of days along the columns of the user interface (e.g., to be the third quantity). For example, when transitioning from the first view to the second view, the electronic device optionally ceases display of one or more rows of one or more days (e.g., displays two to three weeks of representations of day, forgoing display of one or more two weeks of representations of days). In some embodiments, the electronic device displays representations of a plurality of months in the first view, and ceases display of those months when transitioning to presenting months of a year in response to inputs transitioning to the second view. It is understood that the embodiments described herein are merely exemplary, and description of such embodiments optionally apply to different dimensions and/or arrangements of representation of days, weeks, and/or months of the calendar user interface. For example, the electronic device optionally displays days of a given week in a column. In such an example, in response to detecting transitioning from the first view to the second view, the electronic device optionally ceases display of one or more columns corresponding to one or more weeks. Maintaining the number of representation of days along a first dimension of the user interface and changing the number of representations of days along a second dimension of the user interface maintains visual consistency while providing additional space in the user interface to present information associated with representation of calendar items, thus reducing visual clutter and thereby reducing the user's cognitive load when transitioning between views of the user interface.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 900) are also applicable in an analogous manner to method 700 described above with respect to FIG. 7. For example, the operation of displaying a representation of a calendar item described above with reference to method 700 optionally has one or more of the characteristics of displaying representations of calendar items described herein with reference to other methods described herein (e.g., method 900). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, displaying operation 702, 708, and 710, and detecting operation 704 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Users interact with electronic devices in many different manners. In some embodiments, an electronic device is in communication with one or more input devices, a display generation component, and wireless circuitry. In some embodiments, the electronic device presents a user interface including representations of one or more calendar items. The embodiments described below provide ways in which an electronic device displays the representation in accordance with a type of the calendar item. Displaying the representation in accordance with the type of the calendar item reduces the likelihood the user erroneously interacts with representation, due to the visual indication of the type of the calendar item. It is understood that people use devices. When a person uses a device, that person is optionally referred to as a user of the device.

FIGS. 8A-8R illustrate exemplary ways in which an electronic device displays a representation of calendar item based upon the type of the calendar item. The embodiments in these figures are used to illustrate the processes described below, including the processes described with reference to FIG. 7 and/or FIG. 9. Although FIGS. 8A-8R illustrate various examples of ways an electronic device is able to perform the processes described below with respect to FIGS. 7 and/or 9, it should be understood that these examples are not meant to be limiting, and the electronic device is able to perform one or more processes described below with reference to FIGS. 7 and/or 9 in ways not expressly described with reference to FIGS. 8A-8R.

FIG. 8A illustrates embodiments of a user interface for a calendar application. FIG. 8A illustrates an electronic device 500 that is in communication with a display generation component 504 (e.g., a touchscreen). In some embodiments, the electronic device 500 is a mobile device, such as a smartphone, tablet, or wearable device. In some embodiments, display generation component 504 is a touchscreen, a non-touch sensitive display, and/or a projected display in which images are cast into a physical environment of a user of the electronic device 500.

In FIG. 8A, electronic device 500 displays user interface 802, which optionally corresponds to a user interface for a calendar application. For example, user interface 802 in FIG. 8A includes text describing a currently displayed day, dates, and/or days of the week that are being represented (e.g., “M” for Monday, “T” for Tuesday, and the like). In some embodiments, the user interface 802 illustrated in FIG. 8A is displayed in response to detecting a selection input, such as a contact on a touchscreen touching a day. In some embodiments, the user interface 802 illustrated in FIG. 8 A is displayed in response to detecting the input 661 in FIG. 6D. In FIG. 8A, electronic device 500 displays text describing that the currently represented day is a particular day of the week and/or date (e.g., “Thursday, November 4”) and optionally displays representations of calendar items that fall on that day. As described further herein, the various representation of calendar items are optionally displayed with visual characteristics that indicate the calendar instance they are respectively associated with.

In some embodiments, electronic device 500 manages display of representations of calendar items—at times referred to herein as calendar items for brevity—sourced from one or more instances of calendars that are managed by the calendar application. For example, as described further with reference to method 900, electronic device 500 stores and/or receives indications of calendar items including calendar events and/or reminders associated with a work calendar instance, a personal calendar instance, a school schedule instances, and/or the like. In some embodiments, electronic device 500 displays representations of the calendar items. As described further with reference to method 900, a calendar event is optionally a calendar item that is managed by the calendar application, such as a school play or a workout. Additionally or alternatively, a reminder item is optionally managed by a reminder application, different from the calendar application. The embodiments described herein contemplate integration of reminder items into the calendar application, such that a user of electronic device 500 is able to view representations of reminder items without requiring launching of a user interface for the reminder application.

In some embodiments, electronic device 500 visually indicates which instance of a calendar particular calendar items correspond to. For example, in FIG. 8A, electronic device 500 displays representation 803, corresponding a first event that spans the duration of the entire day. Accordingly, representation 803 is displayed at a position relative to the representation of the day, irrespective of a scrolling position (e.g., representation 803 is in the same position in FIG. 8O corresponding to a different period of time included in the day). Similarly, in FIG. 8A, representation 865 and representation 868 are optionally displayed with a same fill pattern, indicating that the corresponding calendar items (e.g., events) correspond to the same instance of the calendar. Respectively, representation 865 and representation 868 are displayed in FIG. 8A with text indicating a title of the item, a time of the item, and in the case of representation 868, a location corresponding to the item. In some embodiments, the items are displayed chronologically. For example, in FIG. 8A, representation 865 is displayed above representation 868 because the event corresponding to representation 865 initiates and concludes at a time before the event corresponding to representation 868 initiates. In some embodiments, the dimension(s) of the representations of items vary based upon duration of the item. For example, representation 865 and representation 868 are displayed with a height corresponding to the duration of the item.

In FIG. 8A, representation 870 is displayed in user interface 802. In some embodiments, the type of the corresponding calendar item dictates the manner in which the electronic device displays the representation of the item. For example, representation 870 is optionally associated with a reminder item, and representation 865 and/or representation 868 in FIG. 8A are optionally associated with a calendar event type item. Accordingly, in addition to displaying the fill pattern of representation 870 in FIG. 8A different from the fill patterns of representations 865 and 868, electronic device 500 displays selectable option 872, included in and/or associated with representation 870. Selectable option 872 is associated with changing a completion status of a reminder that is represented by the representation 870, as described further below. As described further with reference to method 900, a reminder item is optionally associated with a status, such as complete or incomplete, and electronic device 500 optionally facilitates changing of the completion status of a reminder item from the calendar user interface (e.g., without navigating to a reminder application user interface). For example, representation 870 is optionally a combined representation that indicates that a plurality of reminder items are associated with a range of times, such as around 10:00 PM. To indicate the temporal overlap and/or similar times of the reminder items associated with the range of times, representation 870 includes a first shape including first text (e.g., “Meds” and “10 PM”) indicating the first reminder item included in the plurality of reminder items. Additionally or alternatively, representation 870 includes a second shape, spatially offset, and mimicking the appearance that the second shape is “behind” the first shape from the perspective of a user of electronic device 500 in FIG. 8A. Additionally or alternatively, representation 870 in FIG. 8A includes text indicating the quantity of the plurality of reminders (e.g., “(4)”). In contrast, representations 865 and 868 are displayed with a signal shape, and additionally are not displayed with a selectable option.

In FIG. 8A, electronic device 500 detects input 874, corresponding to a selection input directed toward the selectable option 872. In some embodiments, as described above, electronic device 500 changes the completion status of the currently represented reminder item, such as the “Meds” calendar item in representation 870 in FIG. 8A.

FIG. 8B illustrates a change in the combined representation 870 (e.g., to correspond to representation 876) in response to detecting input changing a completion status of a first item. For example, in response to detecting the input 874 in FIG. 8A, electronic device 500 ceases display of the “Meds” reminder item and initiates display of the next item that follows the “Meds” reminder item in time. For example, electronic device 500 in FIG. 8B initiates display of “Pack Clothes,” decrements the number of items that are incomplete as represented by the text “3,” and displays the time corresponding to the currently displayed reminder item (e.g., “10:05 PM”). In FIG. 8B, electronic device 500 detects input 804 directed to representation 876.

From FIG. 8B to FIG. 8C, electronic device 500 updates user interface 802 to include representation of reminders associated with the representation 876. For example, in FIG. 8C, user interface 802 includes a plurality of representations of reminder items 806, which optionally includes a first reminder 808, a second reminder 809, a third reminder 814, and a fourth reminder 810. In some embodiments, electronic device 500 displays selectable options corresponding to each reminder item, and/or indicates the completion status of each reminder item with a fill pattern. For example, fourth reminder 810 in FIG. 8C is displayed with a first fill pattern, indicating it is complete, and the other reminder items are displayed with a second fill pattern, indicating they are incomplete. In FIG. 8C, electronic device 500 detects input 812 directed to the selectable option associated with the third reminder item 814. Accordingly, in FIG. 8D, electronic device 500 changes the display of the fill pattern of the selectable option associated with the third reminder 816 to match the fill pattern of the fourth reminder 810. Thus, electronic device 500 displays reminder 816 indicating that the “Pack Bag” reminder item is complete. Electronic device 500 detects an input 820 directed to a selectable option that is selectable to navigate back to the representation of the events and items associated with a day in FIG. 8D. In response to input 820 in FIG. 8D, electronic device returns to display of user interface included the various reminders and/or events associated with November 4^{th} in FIG. 8E.

In FIG. 8E, due to the change in completion status of the “Pack Bag” reminder, electronic device 500 displays representation 822 with text indicating that the quantity of incomplete reminders has changed. Thus, representation 822 is a combined representation that optionally changes when completion status of reminder items corresponding to the representation change, irrespective of the particular user interface that changes the completion status. In FIG. 8E, electronic device 500 detects input 824 directed to selectable option 826. In response to detecting the input 824 in FIG. 8E, electronic device 500 displays a user interface to facilitate adding an item to be managed by the calendar application.

In FIG. 8F, electronic device 500 displays user interface 802 including a plurality of informational fields and/or selectable options to facilitate entry of a calendar item. In FIG. 8F, user interface 802 corresponds to a calendar event item, which optionally includes a toggle 828 that is selectable to change the type of item that will be added from an event 828a type of item to a reminder 828b type of item. Additionally or alternatively, in FIG. 8F, fields 830 include an “Add Event” field to describe a title, and/or a “Location or call” field to add location information and/or phone numbers associated with the event. Additionally or alternatively, electronic device 500 displays fields to specify a start time (e.g., informational field 838a) and an end time (e.g., informational field 838b). In FIG. 8F, electronic device 500 detects a series of inputs 832, 834, and 836, to initiate input direct to respective informational fields.

In FIG. 8G, electronic device 500 populates the informational fields in accordance with input such as text input from a keyboard or dictation input through a microphone initiated based upon the inputs 832, 834, and 836. Accordingly, electronic device 500 displays the field 830 including “Tennis Lesson” text, and indicates that the start and end time of the event will be 7:30 PM and will be 8:00 PM. In FIG. 8G, electronic device 500 detects input 840 directed to selectable option 842 (e.g., “Add”), and in response, electronic device displays a representation of the newly added item such as shown in FIG. 8H.

In FIG. 8H, electronic device 500 displays the representation of the “Tennis Lesson” event, changing the dimensions of representation 865 (e.g., decreasing the width and preserving the height) to accommodate the concurrent event corresponding to representation 846. Thus, calendar events are optionally displayed separately rather from one another when there is a temporal overlap between the events, as compared to reminder items that are aggregated (e.g., corresponding to representation 822). In FIG. 8I, electronic device 500 detects input 848 selecting selectable option 826.

In FIG. 8I, electronic device 500 initiates display of the user interface 802 for adding an item, and detects an input 850 directed to a selectable option for the reminder 828b type of item. In FIG. 8J, in response to the input 850, electronic device 500 updates user interface 802 to correspond to information fields better suited for reminder type of items. For example, in FIG. 8J, user interface 802 includes fields 858, selectable to add titles of the reminder item and/or notes associated with the reminder item. Additionally or alternatively, in FIG. 8J, user interface 802 includes field 860 which is selectable to initiate entry of a discrete time, rather than a start and an end time, associated with the reminder item. Additionally or alternatively, in FIG. 8J, user interface 802 includes field 862, which is optionally selectable to designate the collection of reminders (e.g., “To Do List”) that the reminder item will be associated with. In FIG. 8J, electronic device 500 detects inputs 852, 854, and 856, respectively directed to fields 858, 860, and 862.

In FIG. 8K, in response to detecting one or more selection inputs, dictation inputs, and/or text-based inputs after detecting selection of fields 858, 860, and 862 in FIG. 8J, electronic device 500 updates user interface 802. For example, user interface 802 includes a title (e.g., “Call Mom”), an updated time (e.g., “Today at 10 PM”), and an updated list of reminders (e.g., “Family Reminders”). In FIG. 8K, electronic device 500 detects input 864 directed to selectable option 842, and in response, adds the reminder item to the collection of reminders managed by the reminder application, and/or represented by the calendar application.

In FIG. 8L, electronic device 500 displays updates user interface 802 to represent the newly added reminder item in response to the input 864 in FIG. 8K. For example, representation 822 in FIG. 8L is updated to include text to indicate that the reminder item that comes first and is the “Call Mom” reminder set for 10:00 PM. Additionally or alternatively, electronic device 500 updates the display of the related selectable option to indicate that the newly added reminder item is associated with the “Family Reminders” list of reminders, as shown by selectable option 866 in FIG. 8L. in FIG. 8L, electronic device 500 detects input 848 directed to selectable option 826, and initiates the process to add another item to the calendar.

In FIG. 8M, electronic device 500 displays the user interface 802 to add a new item to the calendar in response to input 848 in FIG. 8L. In FIG. 8M, electronic device 500 detects inputs 878 and 880 directed to information fields 858 and 860, respectively. In FIG. 8N, in response to detecting inputs 878 and 880 and/or additional or alternative inputs (e.g., text, dictation, and the like), electronic device 500 populates the information fields 858 and 860 (e.g., “Pick up dry cleaning” and “Today at 9 PM”). In FIG. 8N, electronic device 500 detects input 882 directed to selectable option 842 in order to add the reminder item to the reminder application and/or facilitate display of a representation of the new reminder item by the calendar application.

In FIG. 8O, in response to the input 882 in FIG. 8N, electronic device 500 displays the view of the same day, corresponding to the time of the newly added representation 886 (e.g., “Pick up dry cleaning 9:00 AM”). In FIG. 8O, because the representation 886 is beyond a threshold time of the other reminder items scheduled for the same day (e.g., 5, 10, 15, 20, 30, 45, 60, 90, or 120 minutes) electronic device 500 forgoes inclusion of the “dry cleaning” reminder in the other combined representation of item, and separately displays the representation 886. In FIG. 8O, electronic device 500 detects input 884 scrolling down through the day, and in response, again initiates display of the various items scheduled for later in the day. As shown in FIG. 8P, electronic device 500 scrolls to the later portion of the day, and again displays the various reminder and calendar event items, including the combined representation 822 which is separate from the representation 886 illustrated in FIG. 8O.

In FIG. 8P, electronic device 500 detects input 889 directed to selectable option 888, which is optionally selectable to display a list of various calendar items associated with the currently selected day. In FIG. 8Q, electronic device 500 updates user interface 802 to display a listing of the various items scheduled for the day in response to input 889 in FIG. 8P. In FIG. 8Q, electronic device 500 displays representations 890a, 890b, 890c, 890d, 890c, 890f, 890g, 890h, and/or 890i. Representations 890b, 890c, and 890d optionally are associated with calendar items, and accordingly include icons having shapes that correspond to calendar events, and optionally includes text describing the time and/or titles of those events. Representations 890a, 890f, and 890g optionally include similar text, but are displayed with icons having visual characteristics indicating that they represent reminder items associated with a particular list of reminders (e.g., circles with a closed line). Representation 890e is similar to representations 890a, 890f, and 890g, but optionally includes different visual characteristics (e.g., a circle with a dashed line) to indicate that representation 890e corresponds to a reminder item from a different list of reminders. Representations 890h and 890i are optionally similar to representations 890a, 890c, 890f, and 890g, but optionally are displayed with different visual characteristics (e.g., a circle with a darker fill pattern) to indicate completion of the reminder items.

FIG. 9 illustrates a flow diagram illustrating a method in which an electronic device performs display of representation of calendar items according to some embodiments. The method 900 is optionally performed at an electronic device and/or electronic devices such as device 100, device 300, or device 500 as described above with reference to FIGS. 1A-1B, 2-3, 4A-4B and 5A-5H. Some operations in method 900 are, optionally combined and/or order of some operations is, optionally, changed.

In some embodiments, an electronic device in communication with one or more input devices and a display generation component is configured to perform a method 900, such as electronic device 500 in communication with display generation component 504 as shown in FIG. 8A. For example, the electronic device, the one or more input devices, and/or the display generation component have one or more characteristics similar to or the same as those described with reference to method 700.

In some embodiments, while displaying, via the display generation component, a user interface for a calendar application, such as user interface 602 as shown in FIG. 8A, the electronic device detects (902), via the one or more input devices, a first input initiating a process to add a first item to a calendar associated with the calendar application, such as input 824 as shown in FIG. 8E. For example, the calendar user interface and/or calendar application optionally have one or more characteristics similar to or the same as those described with reference to method 700. In some embodiments, the electronic device displays a selectable option in the calendar user interface that is selectable to add an item to a calendar (e.g., the calendar being similar to or the same as one or more of the calendars described with reference to method 700). In some embodiments, a calendar item includes and/or is associated with information that defines a title, a start time, and/or an end time used to display a representation of the calendar item within the calendar user interface. As described further herein, the calendar item optionally is associated with a type of calendar item, such as a reminder item and/or an event item. In some embodiments, the selectable option includes text such as a “+” and/or “add item” and the like, and is selectable to add one or more calendar items into a respective calendar. In response to a selection input, which optionally includes a tapping on the selectable icon, a voice input, and/or a selection with a keyboard and/or trackpad, the electronic device optionally initiates a process to add the item to the calendar. In some embodiments, the first input includes or is a voice input, initiating entry of the item using a voice assistant. As described further herein, the process optionally includes displaying an informational card prompting the user to specify information associated with the item and/or specify a type of item. In some embodiments, the process include specifying which of one or more calendars that a prospective calendar item will be added to during and/or after concluding the process to add the item to the calendar.

In some embodiments, in response to detecting the first input and after the process to add the item to the calendar is complete (904), such as in response to detecting input 864 as shown in FIG. 8K, in accordance with a determination that one or more criteria are satisfied, including a first criterion that is satisfied when the first item is a first type of item associated with a reminder application, the electronic device displays (906), via the display generation component, in the user interface for the calendar application, a first representation of the first item having a first visual appearance, such as representation 822 as shown in FIG. 8L. For example, without detecting additional or alternative inputs after detecting the first input selecting a button and/or requesting initiation of the item-adding process, the electronic device optionally displays an informational card including various fields selectable to specify details regarding the event. In some embodiments, the card overlays a representation of a calendar displayed in the user interface. In some embodiments, the card includes one or more fields to specify a title, time of day, time zone, description, notes, related file attachments, a recurrence of the item, a calendar that the item will be added to, alerts, invitees for the item, a status of a user of the electronic device while the item is ongoing, a link associated with the item, and/or a travel time associated with the event. In some embodiments, in response to detecting selection of a field, the electronic device initiates display of a user interface and/or controls to add and specify details concerning the item (e.g., a keyboard and text box, a dropdown menu, a mini-calendar to specify day(s) of the item, a scrolling interface to change a time of the item, a time zone selector, a calendar toggle inset to specify which of one or more calendars the item will correspond to, and/or some combination thereof). In some embodiments, the card includes controls to toggle and/or specify a type of the item. For example, in a region of the card and/or by displaying a toggling option, the electronic device displays a first selectable option to specify that the item is a first, second, or another type of calendar item. In some embodiments, the item is a reminder associated with a reminder application stored in memory of the electronic device. In some embodiments, the item is a calendar event, different from a reminder item. In some embodiments, the electronic device detects voice input, selection of a representation of the corresponding item (e.g., “event” or “reminder), and/or selection of a similar representation of the corresponding item from a dropdown menu, and in response changes the type of item represented in the card. In some embodiments, the card includes and/or does not include fields and/or information that are less relevant to the current type of item displayed in the card. For example, when the card is displayed corresponding to a reminder item, the card optionally includes a field for “tags” specifying categories of reminders that the user has specified, a toggle to enable display of a suggestion to insert a description of the reminder into a messaging application, a flag and/or priority level associated with the reminder item, inclusion of a list-different from a calendar-associated with a collection of reminder items, subtasks associated with the reminder, image(s) associated with the reminder, and/or some combination thereof. When the card is displayed corresponding to a calendar event, the card optionally includes a field for specifying a related calendar, a selectable option to indicate status of the user during the event, travel time associated with the event, a video call or link associated with the event. It is understood that one or more of the aforementioned fields described with reference to the reminder-type item and/or described with reference to the calendar event-type item are optionally included in the corresponding card, and are optionally not included in the other, non-corresponding card (e.g., a subtask field is included in the reminders card, but not in the event card).

In some embodiments, a reminder item corresponds to a discrete action the user would like to take and/or be reminded about, that is associated with a time in order to trigger the user to take action or remind the user to take action at the prescribed time (e.g., the time that is specified through the informational card in the calendar user interface, or more directly through the reminders application user interface), such as representation 822 as shown in FIG. 8B. In such embodiments, the electronic device displays a selectable option within the calendar user interface to designate whether the user indicated that action was taken, thus facilitating marking of completion of the reminder. In some embodiments, a reminder event does not have a corresponding duration (e.g., a start time and end time)—rather, it has just a “reminder time” (optionally analogous to a start time of a calendar event), which is the time at which the reminder will be presented to the user (e.g., via a notification) for completion. In some embodiments, the calendar event is associated an event that spans a period of time, rather than discretely reminding the user to take action and/or verify that action was taken at a particular time. For example, the calendar event is represented in the calendar user interface visually designating ranges of time (e.g., portions of a day or all day) that is relevant for the event, such as a meeting that last an hour, a soccer camp that spans half of a day, and/or corporate retreat that lasts for all of one or several days. Thus, in some embodiments, a calendar event has a user-configurable duration (e.g., different events can have different durations), while a reminder even does not have a user-configurable (e.g., different reminders do not have different durations, or have the same duration, or have no duration at all but rather single dates/times associated with the reminders, as described above).

In some embodiments, a calendar event and a reminder item are different types of calendar items that have first one or more characteristics that are similar or the same as one another, and second one or more characteristics that are different from one another, such as characteristics of representation 865 and/or representation 876 as shown in FIG. 8B. For example, a calendar event and/or a reminder item are both optionally displayed corresponding to (e.g., within) a representation of a day in the calendar user interface (e.g., included in, overlaying, overlapping with the representation of the day, and/or some combination thereof) associated with a date corresponding to the calendar event and/or reminder item. Additionally or alternatively, the representation of the calendar item is optionally displayed at a relative location relative to the representation of the day indicating the time corresponding to the calendar item. For example, both a calendar event and/or a reminder item are displayed closer toward or at the top of the representation of the day in accordance with a determination that the time of the calendar event and/or reminder item have a start time and/or a reminder time that corresponds to the start of the day, and optionally are displayed closer toward the bottom or at the bottom of the representation of the day in accordance with a determination that the start time and/or reminder time is toward the end of the day. Additionally or alternatively, the representation of the calendar item-optionally irrespective of the type of the calendar item—is optionally displayed with a time corresponding to a start time of the calendar event and/or an assigned time of the reminder item. In some embodiments, a representation of a calendar item-both event and/or reminder type items—are displayed with one or more characteristics of calendar item(s) described with reference to method 700.

In some embodiments, the electronic device displays a calendar item with one or more visual characteristics based upon the type of the calendar item, such as the characteristics of representation 865 and/or representation 876 as shown in FIG. 8B. For example, the electronic device optionally displays a representation of the calendar item as a first visual representation or a second visual representation based upon the type of the calendar item, as described further herein. Additionally or alternatively, the function(s) and/or operations made available by the electronic device when interacting with different types of representation of calendar items are optionally different. For example, when the calendar item is a reminder item, the electronic device optionally facilitates editing information corresponding to the reminder by using the calendar user interface and/or by using a user interface for the reminder application. Additionally or alternatively, as described above with reference to the informational card, the electronic device optionally receives input(s) specifying information inserted to fields associated with the reminder. One of many such fields optionally includes location-sensitive reminders, which are optionally associated with a locomotive context (e.g., entering a vehicle, exiting a vehicle, leaving a location, arriving at a location, and/or some combination thereof). After entering the reminder item (and displaying a representation of the reminder item in the calendar user interface), the electronic device optionally determines whether the electronic device satisfies some criteria related to the locomotive context (e.g., entered the vehicle, exited the vehicle, left or arrived at a location, and/or some combination thereof), and optionally initiates display of a notification of the satisfaction of the criteria (e.g., on a lock screen different from the calendar user interface, overlaying a currently displayed user interface the same as or different from the calendar user interface, and/or audibly announced). In some embodiments, such a field and/or notification-mechanism is not displayed and/or available for calendar items. Another of such fields associated with the reminder item optionally includes subtasks associated with the reminder, that are optionally specified by the user by textual, voice, and/or button-selection. Such subtasks are optionally displayed in response to selection of the first representation of the calendar item displayed in the calendar user interface that has the first visual appearance described further herein (e.g., in addition to, or in the alternative to displaying other reminder items).

In some embodiments, a calendar event information card does not include a field for subtasks; accordingly, the electronic device optionally forgoes display of one or more subtasks in response to detecting selection of the second visual representation of the calendar event that as the second visual appearance that is described further herein. In some embodiments, a calendar event is associated with a duration and/or recurrence. For example, the information card corresponding to the calendar event optionally includes fields selectable to specify a start time and an end time, and the information card corresponding to the reminder item optionally includes a field selectable to specify a time assigned to the reminder item (but optionally does not include a field for an ending time of the reminder). In some embodiments, the card corresponding to the calendar event includes a field designating a recurrence of the calendar event (e.g., daily, weekly, monthly, and/or yearly). In some embodiments, the card corresponding to the reminder item also include a field designating a recurrence of the reminder item.

In some embodiments, the manner in which a recurring calendar item is displayed is dependent upon the type of the calendar item, such as an item corresponding to representation 803 as shown in FIG. 8A. For example, in accordance with a determination that the calendar item is a calendar event that spans several consecutive days, the electronic device optionally displays a visual representation that spans across several representation of several days. In accordance with a determination that the calendar item is a reminder item that spans several consecutive days, the electronic device optionally displays plurality of visual representations that are respectively displayed overlaying and/or included in different respective representations of the consecutive days. In some embodiments, a reminder item is associated with a priority level specified via input directed to a corresponding field in a reminder item-type informational card. In some embodiments, when displaying the representation of the reminder item, the electronic device displays a flag, color, and/or other indication conveying the assigned priority level. In some embodiments, the electronic device does not display a field for assigning priority of an analogous calendar event, and consequentially forgoes display of the flag, color and/or other indication associated with the calendar event.

The reminder application is optionally different from and/or is optionally a software application that is separate from the calendar application stored in memory of the electronic device. In some embodiments, the reminder item (e.g., at times, referred to herein as a “reminder” or in the plural as “reminders”) manages a list of reminders. For example, the list optionally is associated with a title, and is optionally a collection of reminder items. In some embodiments, the reminders application collates a collection of reminders corresponding to different lists, and displays a representation of the collection irrespective of which list the reminder is associated with. In some embodiments, the reminders are associated with a completion status that is different from, and managed by the user. For example, in accordance with a determination that the reminder is marked complete (e.g., by voice, selection of a button, and/or some combination thereof), the electronic device optionally changes the completion status of the reminder, and optionally changes the visual appearance of a representation of the reminder such as a button, graphic, color, translucency, degree of a blurring effect, font-formatting, and/or some combination thereof (e.g., within the calendar user interface and/or within the reminders user interface). In some embodiments, while a reminder item is able to be marked complete (and the electronic device optionally updates the visual appearance of such an item in the calendar user interface upon being marked complete), a calendar event item optionally cannot be marked complete—in the case of a calendar event item, the electronic device optionally updates the visual appearance of a calendar event item, not in response to user input, but rather in response to the time and/or date of the calendar event being in the past (e.g., prior to a current date and/or time at the electronic device).

In some embodiments, when the one or more criteria are not satisfied, the electronic device displays the first representation of the first item having the first visual appearance, such as a with a visual appearance of representation 822 as shown in FIG. 8H. For example, the first type of item optionally corresponds to a reminder that is managed by a reminders application. In some embodiments, the one or more criteria include the first criterion and optionally include additional or alternative criterion (e.g., a criterion that is satisfied when another reminder item corresponding to a representation included in the same day of the calendar user interface corresponds to a time that a is greater than a threshold amount of time from a time of the reminder item corresponding to the first representation (e.g., 0.5, 1, 2.5, 5, 10, 15, 20, 30, 45, or 60 minutes from the time of the reminder item)). In some embodiments, while displaying the information card and after receiving user input specifying information corresponding to the reminder item fields described with reference to the reminder card, the electronic device detects one or more inputs confirming and/or committing the item to the calendar and/or to the reminders application. For example, the electronic device detects touch input selecting a button, voice input(s) confirming and/or adding the reminder item, and/or selection of one or more physical buttons. In some embodiments, in response to such one or more inputs, the electronic device ceases display of the information card, and/or updates the respective view of the calendar user interface to include the newly added reminder item. In some embodiments, the first representation of the item is displayed corresponding to (e.g., overlaying, included within, and/or overlapping with) a representation of a day that corresponds to a date of the reminder, the representation of the day having one or more characteristics similar to or the same as those described with reference to method 700. In some embodiments, the first representation of the item is displayed with one or more visual characteristics similar to or the same as described with reference to method 700. For example, the first representation of the item when displaying a representation of a week of items and/or a day of items optionally includes text indicating the title of the reminder. Additionally or alternatively, the text optionally includes a time associated with the reminder. In some embodiments, the first visual appearance additionally includes a color associated with the item. For example, the first visual appearance optionally includes a color fill, a color of an icon, a color of the text, a color of a border, and/or some combination thereof. In some embodiments, the first visual appearance includes information and/or graphics that are not included in a second visual appearance of an event type of item, such as an icon that is selectable to indicate that the corresponding reminder item is completed. Such information, for example, optionally includes a checkbox, a circle that is not filled with a color pattern, and/or a border surrounding text included in the first visual indication. In some embodiments, when displaying the first visual indication with the first visual appearance, the electronic device forgoes display of some or all aspects of the second visual indication displayed with the second visual appearance described further herein.

In some embodiments, in response to detecting the first input and after the process to add the item to the calendar is complete (904), in accordance with a determination the one or more criteria are not satisfied, and in accordance with a determination that the first item is a second type of item, different from the first type of item, (e.g., associated with the calendar application, and/or not associated with the reminder software application), the electronic device displays (908) via the display generation component, in the user interface for the calendar application, a second representation of the first item having a second visual appearance, different from the first visual appearance, such as representation 846 corresponding to a calendar event item as shown in FIG. 8L. For example, the electronic device optionally displays the seconds visual indication with the second visual appearance, different from the visual appearance of a reminder item when the one or more criteria are not satisfied. After the informational card that corresponds to the event-type of item (and not to the reminder-type of item) is populated with information directed to one or more fields, the electronic device optionally detects one or more inputs confirming and/or committing the event to the calendar application, similar to or the same as described with reference to specifying information in the reminder card. In response to detecting the one or more inputs confirming the event, the electronic device optionally updates the calendar user interface to include the second representation of the item, and/or the electronic device optionally ceases display of the informational card (e.g., and/or forgoes display of the first representation of the item). In some embodiments, the second visual appearance includes colors, indications, and/or text not included in the first visual appearance. For example, the second representation of the item optionally includes a color bar having a size that relatively increases when the event consumes a greater portion of a corresponding day, or optionally, relatively decreases when the event consumes a lesser portion of the day. Additionally or alternatively, the color of the color bar and/or the second visual indication optionally changes based upon a calendar associated with the second visual indication. For example, when the second visual indication corresponds to a work calendar, the second visual appearance optionally includes displaying the color bar with a first color. When the second visual indication corresponds to a sports calendar, the second visual appearance optionally includes displaying the color bar with a second color, different from the first color. Additionally or alternatively, the second visual indication optionally includes a duration of the event (e.g., “9 PM-10 PM,” “all-day,” and/or the like). It is understood that some or all aspects of the second visual indication and/or the second visual appearance are not included in the first visual indication and/or the first visual appearance. In some embodiments, the second representation of the calendar item has one or more characteristics similar to or the same as representation(s) of calendar items described with reference to method 700. Displaying a first or a second visual representation in accordance with a type of calendar item visually differentiates the types of item, thus reducing the likelihood that the user interacts with an expectation that the type of the calendar item is different from its defined type, and thereby reducing processing required to detect and/or correct the erroneous interaction.

In some embodiments, the displaying of the first representation of the first item having the first visual appearance includes overlaying the first representation of the first item over a representation of a day included in the calendar that corresponds to the day of the first item, wherein a first position of the first representation relative to the representation of the day corresponds to a time of the first item, such as a relative time and/or position of representation 886 as shown in FIG. 8O. For example, as described with reference to method 700, the representation of the calendar included in the user interface for the calendar application optionally includes one or more representation of days. The representation of a respective day optionally includes, for example, a day number corresponding to the day, a border defining the region of the user interface that corresponds to the respective day, a name of the day of the week corresponding to that day, times of day included in the day, lines and/or shapes portioning regions of the representation of the day to visually correspond to the displayed times of the day. In some embodiments, the representation of respective day includes some of the day (e.g., one hour, two hours, three hours, six hours, twelve hours) or all of the day. In some embodiments, the electronic device displays representations of calendar items overlaying the representation of the day. For example, a representation of an item that corresponds to the representation of the day (e.g., is assigned to the day) is optionally displayed at a position relative to the representation indicative of time(s) associated with the item. In some embodiments, the item corresponds to the first type of item (e.g., is a reminder item associated with the reminders application), and the electronic device displays the first representation that indicates the first item is associated with the reminders application similarly to how the electronic device displays a representation of the second type of item (e.g., a calendar event associated with the calendar application). For example, the electronic device optionally displays a representation of an item that is assigned to be reminder item occurring at a first time at first position relative to a representation of day. In accordance with a determination that the type of the item is assigned to be calendar item, such as in response to input(s) changing the type of the item, the electronic device optionally displays the representation of the calendar item at the first position relative to the representation of the day. In some embodiments, the scale of the representation of a respective calendar item relative to the user interface for the calendar is variable or is fixed, depending upon the type of the respective calendar item. In some embodiments, when the respective calendar item corresponds to the first type of item such reminder type of item, the electronic device forgoes changing of the scale of the representation of the respective calendar item in accordance with the time and/or a duration of a period of time associated with the reminder item (e.g., displays the first representation of the first item with a first scale relative to the user interface in accordance with a determination that the first item corresponds to a first period of time and/or to a second period of time that is different from the first period of time). In some embodiments, when the respective calendar item corresponds to the second type of item such as the calendar event type of item, the electronic device scales the representation of the respective calendar item in accordance with the time and/or the duration of the period of time associated with the calendar event (e.g., displays the first representation of the first item with a first scale relative to the user interface in accordance with a determination that the first item corresponds to a first period of time, and/or displays the first representation of the first item with a second scale, different from (e.g., larger or smaller than) the first scale when the first item corresponds to a second period of time that is different from the first period of time). In some embodiments, the scale of a representation of a reminder item is similar to or the same as the scale of a representation of calendar event that corresponds to a respective duration (e.g., 5, 10, 15, 20, 30, 45, or 60 minutes).

The order of representation of items of a given day, such as the first representation of the first item, is optionally chronological, such as the order of representation 865 and/or 868 as shown in FIG. 8P. For example, in accordance with a determination that the first item is a calendar event that begins at a time before the start time of a second item, the representation of the first item is optionally displayed above the representation of the second item (e.g., when a top of the representation of the day corresponds to midnight, and/or when a bottom of the representation of the day corresponds to 11:59 PM of the day). Similarly, in accordance with a determination that the first item begins at a time after the second item, the electronic device optionally displays the first representation of the first item below the representation of the second item. It is understood that the aforementioned embodiments are merely exemplary; the chronology of items corresponding to a respective day represented in the user interface for the calendar application is optionally represented in a left-to-right or vice-versa and/or is bottom-to-top direction.

In some embodiments, while displaying a first representation of a first day, the electronic device detects one or more respective inputs such as a contact on a touch-sensitive surface and/or an air gesture (e.g., an air pinch including contact between fingers of a hand moving in a three-dimensional environment of the user, an air pointing including an extending of one or more fingers and/or movement while the one or more fingers are extended, and/or an air curling of the one or more fingers and/or movement while the one or more fingers are curled). In some embodiments, in response to detecting the one or more respective inputs, the electronic device updates the currently displayed representation to correspond to a different day. For example, in response to detecting the one or more respective inputs, and in accordance with a determination that the one or more respective inputs include a first input in a first direction (e.g., upwards, downwards, leftward, rightward, away from a body of the user in a depth direction parallel to a floor of the user, toward the body of the user in a depth direction parallel to the floor, and the like) the electronic device optionally changes the representation of the day from the first day to a second day, and/or initiates display of representations of various calendar items corresponding to the second day. In accordance with a determination the one or more respective inputs and/or the first input include an input in a second direction (e.g., leftward instead of upward, rightward instead of downward, upward instead of leftward, and/or in other directions), different from the first (e.g., not including input in the first direction), the optionally performs an alternative operation. For example, the electronic device optionally scrolls the representation of the first day and forgoes display of the representation of the second day. In some embodiments, the electronic device displays representation of items that correspond to an updated scrolling position relative to the first day in response to respective input(s) in the second direction. Thus, the electronic device optionally changes what day is currently represented via the display generation component in response to input in a first direction, and optionally initiates display of calendar items corresponding to a currently displayed day in response to detecting input in a second direction.

In some embodiments, in accordance with a determination that that one or more items, different from the first item, corresponds to the day of the first item, the electronic device displays, via the display generation component, one or more visual representations corresponding to the one or more items overlaying the representation of the day, wherein respective positions of the one or more visual representations relative to the representation of the day correspond to respective times associated with respective items included in the one or more items, such as a relative time and/or position of representations 865 and/or 886 as shown in FIG. 8P. For example, in accordance with a determination that additional or alternative calendar item(s) correspond to the same day as the first item, and while display the representation of the day that the first item corresponds to, the electronic device optionally displays additional or alternative representation(s) of the additional or alternative calendar item(s). In some embodiments, different types of representations of item are displayed concurrently. For example, the electronic device optionally displays the first representation of the first item with the first visual appearance corresponding to first time in the representation of the day, and concurrently and/or optionally displays a second representation of the second item with the second visual appearance corresponding to a second time in the representation of the day. In some embodiments, the representations of the one or more items are displayed at times assigned to the one or more items, such as start times, end times, durations, and/or reminder times (e.g., discrete times not associated with a duration). In some embodiments, the electronic device displays the representations of items corresponding to the day chronologically, as described above. For example, in accordance with a determination that the first item is assigned a time that is earlier in the day than a respective item of the one or more items, the electronic device optionally displays the first representation of the first item above the representation of the respective item. In accordance with a determination that the first item is assigned a different time that is later in the day than the respective item, the electronic device optionally displays the first representation of the first item below the representation of the respective item. In some embodiments, in accordance with a determination that the time associated with the first item overlaps with one or more times assigned to a respective item, the electronic device displays a representation of the first item. Displaying representations of different types of items overlaying a representation of a day reduces user input required to separately display the representation of the different types of items, thereby reducing power consumption required to perform operations related to the user input.

In some embodiments, the process to add the first item to the calendar includes displaying, via the display generation component, a first view of an item entry user interface, such as the portion of user interface 802 as shown in FIG. 8F, wherein the first view of the item entry user interface includes one or more selectable options that are respectively selectable to change the type of the first item from the first type of item to the second type of item, such as toggle 828 as shown in FIG. 8F. For example, while displaying the user interface for the calendar application described with reference to methods 700 and/or 900, the electronic device optionally detects an input directed to a selectable option, a button, and/or voice input requesting initiation of calendar item entry. In response to detecting such input, the electronic device optionally displays an item entry user interface, such as the card described with reference to method 900. The card optionally includes a selectable option that is selectable to toggle between entering information for a calendar event-type item and a reminder-type item, and is thus selectable to change from the first view to the second view of the item entry user interface. In response to detecting selection input directed to the toggling selectable option, the electronic device optionally changes the view of the item entry user interface, which optionally includes displaying and/or forgoing display of information included in the card. For example, the electronic device optionally ceases display of representation of fields that are less relevant to a particular type of item, such as an ending time that is included when displaying the first view that card optionally corresponds to a calendar event and is not included when displaying the card that corresponds to a reminder. It is understood that the selectable option to change the view of the user interface is optionally different from a toggle button. For example, the selectable option is a visual slider that changes between several views of the item entry user interface to enter additional or alternative types of items into the calendar application. The electronic device optionally detects movement of the slider in response to detecting an air gesture, movement of contact on a trackpad, and/or a voice input, and optionally changes between various views of the item entry user interface. Changing the type of view of the item entry user interface reduces the likelihood the user assigns the type of the item to be an undesired type of item, thus reducing user input and the corresponding processing required to perform operations correcting the type of the item.

In some embodiments, the first view of the item entry user interface includes one or more informational fields that are respectively selectable to enter information associated with the first item, such as informational fields 830, 838a, and/or 838b as shown in FIG. 8F. For example, the one or more informational fields have one or more characteristics similar to or the same as described with reference to method 900. In some embodiments, in response to detecting selection input directed to the fields and/or text identifying the fields, the electronic device initiates entry of information assigned to an item that is being added to the calendar and/or calendar application.

In some embodiments, while displaying the first view of the item entry user interface, the electronic device detects, via the one or more input devices, one or more inputs indicating first information directed to a first field of the one or more informational fields associated with the first item, such as input entered after and/or in conjunction with input 832 as shown in FIG. 8F. For example, the electronic device optionally detects selection input directed toward the first field, voice input directed toward the first field, handwritten input directed to a trackpad and/or touch-sensitive surface, an air gesture forming letters and/or interacting with a virtual keyboard, and/or keystrokes directed to a physical keyboard. In some embodiments, the information entered includes express input such as the keystrokes and/or a transcription of the user voice. In some embodiments, the information entered is intelligently determined. For example, in response to detecting a voice input broadly specifying information directed to the first field (e.g., “let's say 7 PM,” “maybe we could invite Randy,” “just pick something close by that is open at 6:00”), the electronic device optionally uses one or more machine learning models and/or obtains information from another device running such one or more machine learning models to extract information that that is thereafter entered to and/or assigned to the first field (e.g., a 7:00 PM event time, including “Randy” from a user's contact list in an invitation for a calendar item, and/or selecting a restaurant in the user's proximity that is open at 6 o'clock).

In some embodiments, in response to detecting the one or more inputs indicating the first information, the electronic device displaying, via, the display generation component, a first visual representation of the first information in the item entry user interface, such as information included in informational fields 830 as shown in FIG. 8G (e.g., “Tennis Lesson”). For example, the electronic device optionally displays text that the user entered by voice and/or keyboard input, pictures corresponding an entered destination, addresses corresponding to an entered location, a representation of a map corresponding to the address, and additional or alternative information described with reference to information field(s) herein.

In some embodiments, while displaying the first view of the item entry user interface that includes the first visual representation of the first information, the electronic device detects, via the one or more input devices, second input directed to the one or more selectable options to modify the selected type of the first item, such as input 850 as shown in FIG. 8I. For example, the selectable option that the user is optionally able to toggle to change the view of the item entry user interface.

In some embodiments, in response to detecting the second input directed to the one or more selectable options to modify the selected type of the first item, the electronic device changes the type of first item in accordance with the input, such as changing the type of item from a calendar event to a reminder item as shown from FIG. 8I to FIG. 8J. For example, the electronic device optionally ceases display of some or all information corresponding to the first view in response to a toggling to optionally display the second view of the item entry user interface (or vice-versa).

In some embodiments, in response to detecting the second input directed to the one or more selectable options to modify the selected type of the first item, the electronic device displays, via the display generation component, a second view of the item entry user interface, such as included in user interface 802 as shown in FIG. 8J. For example, as described with reference to the views of the item entry user interface, the electronic device optionally changes from displaying information relating to a calendar event to displaying information relating to a reminder, or vice-versa. In some embodiments, when there is information in common between the calendar event and/or the reminder item, such as a title and/or a start time associated with the item, the electronic device preserves display and/or replicates display of the same information when changing between the views of the item entry user interface.

In some embodiments, in response to detecting the second input directed to the one or more selectable options to modify the selected type of the first item, the electronic device displays, via the display generation component, a second representation of the first information in the second view of the item entry user interface, such as the time entered into informational fields 860 as shown in FIG. 8J, which corresponds to the time indicated in informational field 838a as shown in FIG. 8I. For example, the electronic device optionally maintains display of the first information such as the start time, the title of the item, a date of the item, a selectable option to specify a recurrence of the item, a location of the item, and the like. In some embodiments, some or all of the information is imported when changing between views of the item entry user interface, similarly to or the same as described herein with reference to “less relevant” information and/or fields. In some embodiments, the electronic device imports information between the views of the user interface irrespective of whether the information is “complete.” For example, when the input toggling between the first and the second view of the item entry user interface is detected, the electronic device optionally displays text that only partially indicates a title of a calendar item and/or includes a first number corresponding to a time of day (e.g., “5,” “6,”, and/or “12”) but optionally does not display additional numbers and/or a time of day (e.g., does not display “:00,” “:30,” “AM,” and/or “PM”). In response to detecting the input, the electronic device optionally displays the partial text and/or the first number included in the second view of the user interface, despite the fact the user is optionally continuing to edit the details associated with the corresponding item. In some embodiments, the information is replicated, such as moved relative to the user interface to accommodate display of informational fields included in a respective first view of the item entry user interface that are not included in a respective second view of the item entry user interface. Displaying representation of information that is relevant to the first and the second types of calendar items reduces user input required to reenter such information when changing between the views of the item entry user interface, thereby reducing processing required to perform operations related to the user input.

In some embodiments, while displaying the second view of the item entry user interface, the electronic device detects, via the one or more input devices, third input directed to one or more second selectable options included in the second view of the item entry user interface that are selectable to change the type of the first item, such as an input directed to event 828a in FIG. 8K. For example, the third input optionally has one or more characteristics similar to or the same as described with reference to the second input. As an example, the third input optionally includes selection of the selectable option to toggle from the second view of the user interface to the first view of the user interface.

In some embodiments, in response to detecting the third input the electronic device changes the type of first item in accordance with the third input, such as displaying the content included in user interface 802 as shown in FIG. 8J (e.g., as described with reference to the second input). In some embodiments, in response to detecting the third input the electronic device displays, via the display generation component, the first view of the item entry user interface such as displaying the content included in user interface 802 as shown in FIG. 8J (e.g., as described with reference to the second input).

In some embodiments, in response to detecting the third input the electronic device displays, via the display generation component, the first representation of the first information in the first view of the item entry user interface, such as the time included in informational field 860 as shown in FIG. 8J. For example, as described with reference to the second input, the electronic device optionally maintains display and/or replicates display of representations of information when changing between views of the user interface. It is understood that in response to detecting additional or alternative inputs changing between views of the user interface, the electronic device optionally continues to maintain display and/or replicate display of the information that is common to the first type and/or the second type of calendar item. In some embodiments, the electronic device again-displays information entered when initially displaying the first view of the user interface. For example, the electronic device optionally initiates display of the first view of the item entry user interface, and optionally enters information relating to an end time of a calendar event and displays information corresponding to the end time of the event. In response to input changing to the second view of the item entry user interface, the electronic device optionally ceases display of such end time information. In response to another input changing from the second view back to the first view, the electronic device optionally displays the first view of the user interface including the end time information. In some embodiments, in accordance with a determination that a respective informational field is not populated by the user, the electronic device does not display the respective information field with information (e.g., the end time of the event described previously) when transitioning between the first view and the second view, or vice-versa. Changing from the second view to the first view and displaying representations of information allow the user to readably change the view of the item user interface, thus reducing user input and thereby power consumption required for operations relating to the user input attempting to reenter information.

In some embodiments, the first input is detected while a respective item, different from the first item, exists in the calendar and is the first type of item, such as an item represented by representation 822 as shown in FIG. 8E (e.g., “Pack Clothes”), wherein the respective item corresponds to a respective time of a day that is within a threshold amount of time of a first time of the first item (e.g., 0, 0.5, 1, 2.5, 5, 10, 15, 20, 30, 45, 60, or 90 minutes), and the one or more criteria include a criterion that is satisfied when the first time of the first item is outside of the threshold amount of time of the respective time of the respective item: In some embodiments, the electronic device maintains and/or manages a plurality of calendar items and changes how representations of such items are displayed in accordance with a determination that there is a temporal overlap between respective items and/or in accordance with a determination of the type of the overlapping items. The overlap, for example, optionally includes a determination that the first item is within the threshold time of another item. In some embodiments, such an “other” item corresponds to an item that is the closest to the first item in time. In some embodiments, the “other” item corresponds to an item included in a plurality of items that are temporally similar to the first item. For example, the plurality of items optionally corresponds to respective times that each fall between 10:00 AM and 10:10 AM, and the first item corresponds to 9:55 AM. In such an example, the electronic device optionally displays a combined representation of the plurality of items and of the first item, without separately displaying a representation of the first item because the time corresponding to the first item is within 15 minutes of a midpoint of the times of the plurality of items (e.g., 9:55 AM is within fifteen minutes of 10:05 AM). It is understood that additional or alternative methods of determining inclusion of the first item in a combined representation of a plurality of items that are within a threshold amount of time are optionally contemplated, such as determining whether the threshold amount of time is a first value or a second value based upon if the representation of the day includes a first amount of time (e.g., four hours of a day) or a second amount of time (e.g., twelve hours of the day).

In some embodiments, in accordance with a determination that the overlapping items are reminder items, the electronic device displays a visual indication and/or a visual representation that indicates that multiple reminders are “stacked,” such as series of corners of shapes that are vertically and/or horizontally offset, overlapping one another to simulate the appearance of a stack of cards and/or papers that are set on a table and are spatially offset such that the corners of the papers are respectively visible. In accordance with a determination that the overlapping items are calendar events, the electronic device optionally forgoes display of a visual indication that conveys that a single representation corresponds to multiple calendar items. With such a determination, the electronic device optionally changes one or more dimensions of representation of the calendar items such that representations of the respective items that overlap in time are both displayed and/or visible.

In some embodiments, in response to detecting the first input and after the process to add the first item to the calendar is complete (e.g., as described with reference to method 900) in accordance with the determination that one or more second criteria are satisfied, including a criterion that is satisfied when the first item is the first type of item associated with the reminder application, the electronic device displays a combined representation of the first item and the respective item in the user interface, such as representation 822 as shown in FIG. 8L. In some embodiments, the electronic device ceases display of a representation of a first type of item, and initiates display of the combined representation when the second one or more criteria are satisfied. Thus, the electronic device optionally replaces display of a representation of a single reminder item with the combined representation (e.g., of the single and the first items), such as when adding the first item to the calendar to the first time that is within the threshold amount of time of the single reminder item. For example, the one or more second criteria are optionally similar to, but optionally different from the one or more described with reference to method 900. As an example, the one or more second criteria include some or all of the one or more criteria described with reference to method 900, and optionally includes a criterion that is satisfied when the first item is associated with a time that is within the threshold amount of time described with reference method 900 (e.g., the one or more criteria described with reference to method 900 includes a criterion that is satisfied when the first item is associated with a time that is not within the threshold amount of time described with reference to method 900). The combined representation optionally is different from a discrete representation of an item. For example, the combined representation optionally visually resembles the series of one or more stacked papers and/or shapes, as described previously, and the representation of the item that is earliest in time corresponding to the combined representation is optionally displayed overlaying the stacked shapes. Thus, the “topmost” item of the stack is optionally the first representation of the first item when the first item is earlier than other items. In response to detecting user input changing the time of the first item that is topmost on the stack, the electronic device optionally moves that same first representation from a first position (e.g., overlaying the stack) to a second position relative to the representation of the day, and initiates display of another representation that temporally followed the first item in time at the first position (e.g., newly overlaying the stack of other items). In some embodiments, the combined representation conveys the underlying density of the items. For example, the combined representation optionally changes a visual characteristic from a first value to a second value in response to input adding an item to the stack. For example, in response to detecting input adding the first item to within the threshold time of a reminder represented by the combined representation, the electronic device optionally changes increases the number of shapes included in the stack, increases an opacity of the stack, and/or increases widths of lines included in shapes that are included in the stack.

In some embodiments, in accordance with the determination that the one or more second criteria are not satisfied, and in accordance with the determination that the first item is the second type of item, different from the first type of item, the electronic device displays the second representation of the first item having the second visual appearance and forgoing display of the combined representation of the first item and the respective item, such as the representation 846 as shown in FIG. 8L. For example, the electronic device optionally forgoes display of the combined representation when the newly added first item is a calendar event, as described above. The newly added representation of the calendar event optionally is optionally displayed concurrently with a representation of a preexisting representation of a calendar event that temporally overlaps with the added representation of the calendar event. In some embodiments, the representation of the newly added event is displayed with a scale different from if the new calendar event did not temporally overlap with another calendar event, such as decreasing a height and/or width of the newly added representation and/or similarly changing the scale of the other overlapping representation(s) of other calendar events. Displaying a combined representation when the item is the first type of item reduces visual clutter, thereby reducing cognitive load of a user of the electronic device.

In some embodiments, while displaying the combined representation of the first item and the respective item because the one or more second criteria are satisfied, the electronic device detects, via the one or more input devices, a second input directed to the combined representation of the first item and the respective item, such as input 804 as shown in FIG. 8B. For example, the electronic device optionally detects a selection input directed to the combined representation and/or to the representation of the first item (e.g., directed to the representation of the first item sitting atop the stack of representation of items and/or directed to the shapes that comprise the stack).

In some embodiments, in response to detecting the second input, the electronic device displays, via the display generation component, a plurality of representations of items associated with the reminder application, including a respective first representation of the first item and a respective second representation of the respective item, such as reminders 808, 809, and/or 814 as shown in FIG. 8C. For example, the electronic device optionally displays a listing of the reminders associated with the reminders application. In some embodiments, the listing includes reminders that are represented by the stack, and does not include reminders that fall on the same day but are not within the threshold time of the reminder(s) included in the stack. For example, the plurality of representation of items (e.g., the listing of the reminders) optionally includes the first representation and/or a representation of the respective item. In some embodiments, the respective first and/or respective second representation of the items have one or more characteristics similar to or the same as described with reference to the representation of the first item. For example, the representation of the items in the listing optionally includes title(s), time(s), and/or checkbox(es) that are optionally also displayed when the electronic device displays the representation of the day without displaying the listing. In some embodiments, the electronic device displays representations of selectable options corresponding to one or more of the items represented in the listing that are respectively selectable to change a completion status associated with corresponding items. For example, the electronic device optionally displays the check box or another shape corresponding to the first item, and in response to detecting selection input directed to the check box or the other shape, optionally changes a completion status of the first item (e.g., from complete to incomplete, or incomplete to complete). Displaying a plurality of representations of items associated with the reminder application that includes representations of the first item and of the respective item provides a convenient mechanism for accessing relevant reminder items that correspond to the combined representation, thus reducing user inputs required to access the reminders application and reducing the user's cognitive load required to determine which reminder items correspond to a day and/or period of time, thereby reducing the power consumption of the electronic device required to detect the user inputs and/or enhancing the fluidity of interacting with the reminder and/or calendar application.

In some embodiments, the combined representation of the first item and the respective item includes a representation of a quantity of items associated with the reminder application, wherein the quantity of items includes items that correspond a period of time associated the first item and the respective item, such as the quantity of incomplete reminders indicated in representation 822 as shown in FIG. 8E. For example, as described above, the combined representation optionally indicates a density of the items corresponding to the combined representation. The density, for example, is optionally quantified. For example, the electronic device optionally displays a number of items (e.g., reminder items) that correspond to the combined representation, such as next to a title of a topmost reminder in the stack of reminders and/or included in a checkbox (or other shape) displayed adjacent to the combined representation. In some embodiments, the combined representation represents a period of time (e.g., 0.5, 1, 2.5, 5, 10, 15, 20, 30, 45, or 60 minutes). For example, the electronic device optionally determines 30 minute windows of a day. In accordance with a determination that the first item and the respective item correspond to a first period of time (e.g., the first window), the electronic device optionally displays the combined representation overlaying a portion of a representation of the day corresponding to the first period of time (e.g., 10:00 AM to 10:30 AM). In accordance with a determination that the first item and the respective item correspond to a second, different period of time, the electronic device optionally displays the combined representation overlaying another portion of the representation of the day correspond to the second period of time (e.g., 11:00 AM to 11:30 AM). As described with reference to the threshold period of time, the electronic device optionally adjusts the value of the windows of time in accordance with a current scale of the user interface, optionally increasing the amount of time included in a respective window when the representation of the day is a first scale (e.g., including a relatively greater number of hours) and optionally decreasing the time included in the respective window when the representation of the day is a second scale (e.g., including a relatively fewer number of hours), or vice-versa. Visually indicating the quantity of items reduces user input, and thereby processing required to detect the user input, that is required to determine the quantity of items associated with the combined representation.

In some embodiments, the quantity of items associated with the reminder application that correspond to the period of time associated with the first item and the respective item are associated with a first completion status, such as the quantity of incomplete reminders indicated in representation 822 as shown in FIG. 8E. For example, as described above, reminder items are optionally associated with a completion status. The first completion status, for example, optionally corresponds to an “incomplete” status, which is associated with items that are quantified such that the user is aware how many reminders of potential interest are pending for further action. In some embodiments, the quantity of items does not include a quantity of items corresponding to the second completion status such as a “complete” status. For example, in response to detecting the combined representation the electronic device optionally displays a listing of the reminders that corresponds to the combined representation. The listing optionally includes a quantity of items (e.g., reminders) that is different than represented in the combined representation, because at least one or more of the items included in the listing are marked complete by the user. Thus, the number and/or quantity of reminder items indicated in the combined representation is optionally independent of the number of “completed” items associated with the second completion status. In some embodiments, the electronic device detects selection input directed to a selectable option displayed overlaying a representation of a day (e.g., a checkbox or other shape) included in the calendar user interface, and in response, changes the completion status of the first item from the first completion status to a second completion status and/or decrements the number of incomplete reminders included in the representation of the day. Additionally or alternatively, in response to detecting user input changing a time of a respective reminder item to correspond (e.g., fall within) the period of time corresponding to the combined representation, the electronic device optionally changes the quantity of reminders of the combined representation in accordance with a determination that the respective reminder item is associated with the first status, and forgoes changing the quantity of the reminders in accordance with a determination that the respective reminder item is associated with the second status. In some embodiments, the selection input is detected while displaying a user interface for the reminders application and is directed to a selectable option similar to the selectable option described with reference to the calendar user interface. In response to detecting such a selection input, the electronic device optionally changes the completion status of the first item (e.g., from incomplete to complete). In response to detecting input initiating display of the calendar user interface, the electronic device optionally decrements the number of incomplete reminders due to the completion of the first item that was detected while interacting with the user interface for the reminder application (e.g., without detecting selection in the calendar user interface) similarly to as though the selection input were directed to the selectable option included in the calendar user interface. Visually indicating the number of reminders associated with the first completion status reduces user input required to independently determine the number of such reminders corresponding to the combined representation, thereby reducing power consumption of the electronic device required to detect and perform operations in accordance with the user input.

In some embodiments, displaying the combined representation of the first item and the respective item includes in accordance with a determination that the first time corresponding to the first item is earlier in the day than the respective time corresponding to the respective item, the combined representation includes information corresponding to the first item, such as representation 822 as shown in FIG. 8L which includes information entered as shown in FIG. 8K. For example, as described above, the electronic device optionally displays a representation of an item that is earliest in time, is associated with the first completion status described herein (e.g., is incomplete), and/or corresponds to the combined representation. The combined representation optionally includes a representation of the first item, for example, similar to or the same as the first representation of the first item described with reference to method 900. Thus, the information corresponding to the item is optionally similar to or the same as the information described with reference to the first representation of the first item. Accordingly, electronic device optionally forgoes display of information corresponding to the respective item when the first time is earlier in the day than the respective time.

In some embodiments, in accordance with a determination that the respective time corresponding to the respective item is earlier in the day than the first time corresponding to the first item, the combined representation includes information corresponding to the respective item, and does not include the information corresponding to the first item, such as displaying representation 822 similar to as shown in FIG. 8L, but not including the information entered as shown in FIG. 8K. For example, in accordance with a determination that the respective item is the earliest item that corresponds to the combined representation (e.g., is earlier in time than the first item), the electronic device optionally displays a title, time, description, a picture, and/or some combination thereof corresponding to the respective item and optionally forgoes display of similar information describing the first item. It is understood that if another item is associated with the first completion status and/or is earlier in the day than any other item corresponding to the combined representation, the electronic device optionally displays information corresponding to the other item similar to or the same as described with reference to the first item and/or the respective item. Displaying information corresponding to an item that is earlier in the day than a time of the first item reduces the likelihood the user erroneously is unaware about a time-sensitive item that the user potentially would like to be aware about instead of other items.

In some embodiments, the one or more criteria include a criterion that is satisfied when the first time of the first item is outside of a threshold amount of time of a respective time of other items of the first time in the calendar, such as the time entered into informational field 860 as shown in FIG. 8N. For example, as described further herein with reference to method 900 and/or with reference to the “combined representation,” the electronic device optionally displays a combined representation of the first item when the first item is within the threshold time (e.g., 0.5, 1, 2.5, 5, 10, 15, 20, 30, 45, or 60 minutes from the time of the reminder item) of the respective item and/or within the threshold time of additional or alternative items. In some embodiments, the electronic device displays the representation of the first item separately from the combined representation of other items in accordance with a determination that the first time corresponding to the first item is outside of the threshold amount of time. Further description of such embodiments and examples are contemplated, as described with reference to the “stack” of reminder items herein.

In some embodiments, in response to detecting the first input, after the process to add the first item to the calendar is complete, and in accordance with a determination that one or more second criteria are satisfied, including a criterion that is satisfied when the first item is the first type of item associated with the reminder application (e.g., as described with reference to method 900) in accordance with a determination that a time corresponding to the first item is within the threshold amount of time of a respective time corresponding to a respective item in the calendar (and that optionally precedes the respective time), the electronic device displays a combined representation of the first item and the respective item in the user interface for the calendar application, such as representation 822 as shown in FIG. 8L. For example, as described further herein with reference to method 900 and/or with reference to the “combined representation.” Displaying a combined representation when the item is the first type of item reduces visual clutter, thereby reducing cognitive load of a user of the electronic device.

In some embodiments, while displaying the combined representation of the first item and the respective item, the electronic device detects, via the one or more input devices, a second input, different from the first input, selecting the combined representation, such as input 804 as shown in FIG. 8B.

In some embodiments, in response to detecting the second input, the electronic device displays, via the display generation component, a plurality of representations of items managed by the reminders application, including the first item and the respective item, wherein the plurality of representation of items are displayed in a chronological order, such as reminders 808, 809, and/or 814 as shown in FIG. 8C. For example, similarly to or the same as described with reference to the “listing” of items displayed by the electronic device in response to detecting selection of the combined representation of the first item and the respective item. Displaying a plurality of representations of items associated with the reminder application that includes representations of the first item and of the respective item provides a convenient mechanism for accessing relevant reminder items that correspond to the combined representation, thus reducing user inputs required to access the reminders application and reducing the user's cognitive load required to determine which reminder items correspond to a day and/or period of time, thereby reducing the power consumption of the electronic device required to detect the user inputs and/or enhancing the fluidity of interacting with the reminder and/or calendar application.

In some embodiments, in response to detecting the first input, after the process to add the first item to the calendar is complete, and in accordance with the determination that the one or more second criteria are satisfied
in accordance with a determination that the time corresponding to the first item is not within the threshold amount of time of the respective time corresponding to the respective item, the electronic device forgoes display of a combined representation of the first item and the respective item, wherein the first representation of the first item is displayed separately from the representation of the respective item, such as not displaying representation 822 and/or instead displaying representation 886 as shown in FIG. 8O. For example, the electronic device optionally displays a representation of the first item separately from representation of the respective item and/or separately from combined representation of a plurality of items that are different from the first item, as described further with reference to embodiments in which the first item temporally overlaps with—or does not overlap with—the respective item and/or additional or alternative items. In such an example, the representation of the item is optionally similar to or the same as the first representation of the first item described with reference to method 900. Displaying the first representation separately from the representation of other items visually indicates that the first item corresponds to a time that beyond the threshold amount of time from the other items, thus reducing the likelihood that the user provides inputs attempting to understand a sequence of various items throughout a day, and thereby reducing processing required to perform operations in accordance with such inputs.

In some embodiments, after the process to add the first item to the calendar as complete, wherein the first item is the first type of item, the electronic device detects, via the one or more input devices, one or more inputs including a request to initiate display of a user interface of the reminder application, different from the calendar application, such as one or more inputs to display a user interface different from the user interface 802 for the calendar application as shown in FIG. 8Q (e.g., including representations corresponding to representation 890a, 890c, 890f, 890g, 890h, and/or 890i). For example, the one or more inputs and/or the request include a voice command specifying the reminder application, a series of one or more contacts and/or movement of contacts on a touch screen or trackpad, a selection of one or more buttons, one or more air gestures directed toward virtual object(s) and/or content corresponding to the reminder application, and/or some combination thereof.

In some embodiments, in response to detecting the one or more inputs, the electronic device displays, via the display generation component, a respective first representation of the first item in the user interface of the reminder application, such as a representation corresponding to representation 890a that is illustrated in FIG. 8Q. For example, in response to detecting the one or more input(s), the electronic device optionally ceases display of the calendar user interface and initiates display of a user interface corresponding to the reminder application. In some embodiments, the reminders application includes a plurality of selectable options and/or information corresponding to collections of reminder items and/or corresponding to periods of time. The reminder application user interface optionally includes a selectable option for items that correspond to a current day, that are optionally associated with a time (e.g., as opposed to items that are not associated with a time), a superset of all reminders managed by the application, that are optionally expressly flagged by the user, that are optionally associated with a “complete” completion status, and/or that optionally correspond to a first and/or second user account associated with the electronic device. In some embodiments, the electronic device detects selection of a selectable option corresponding to a respective collection, and in response displays a listing of the collection of associated items. In such a listing, the electronic device optionally includes the respective first representation of the first item, which optionally corresponds to the first representation of the first item. In some embodiments, the respective first representation of the first item has one or more characteristics similar to or the same as described with reference to the first representation of the first item. In some embodiments, in accordance with a determination that the first item is changed to correspond to the second type of item, the electronic device forgoes display of the respective first representation when displaying the listing of the collection of associate items (e.g., because calendar events are not managed by the reminder application). It is understood that in some embodiments, the operations described with reference to the user interface for the reminder application are performed while the electronic device does not display the user interface for the calendar application. Including a representation that corresponds to the first item when displaying the user interface for the reminder application reduces user input required to launch the user interface for the reminder application and enter information corresponding to the first item, thus synchronizing the listing of reminders managed by the two applications, thereby reducing processing required to perform operations related to the additional user input.

In some embodiments, while displaying the first representation of the first item in the calendar application, such as representation 870 as shown in FIG. 8A, wherein a completion status of the first item is a first completion status, the electronic device detecting, via the one or more input devices, a second input, different from the first input, directed to the first representation, such as input 874 directed to selectable option 872 as shown in FIG. 8A. For example, the completion status, the first completion status, and/or the second input have one or more characteristics described with reference to similar terms and concepts described herein. For example, the first item is optionally set to an incomplete status when the second input (e.g., a selection of a checkbox) is detected.

In some embodiments, in response to detecting the second input, the electronic device modifies a visual appearance of the first representation to be a second visual appearance, different from the first visual appearance, and the electronic device updates the completion status of the first item to be a second completion status, different from the first completion status, such as the modification of the representation 876 from FIG. 8A to FIG. 8B, and/or the changing in completion status of the item represented in FIG. 8A. For example, the electronic device optionally changes the visual appearance of the representation of the first item and/or ceases display of the representation of the first item in response to detecting the second input. Thus, the electronic device optionally facilitates changing of the completion status of the first item without requiring user input to display a user interface corresponding to the reminder application, or more generally without having to leave the user interface of the calendar application (e.g., while maintaining display of the user interface of the calendar application and without displaying a user interface of the reminder application), and separately updating the completion status of the first item in the reminder application. In some embodiments, the first and second visual appearances differ with respect to one or more values of one or more visual characteristics. For example, the first visual appearance and the second visual appearance optionally correspond to different color values (e.g., black when the first item is incomplete, gray when the first item is complete). Additionally or alternatively, the electronic device optionally maintains respective characteristics such as font color, and optionally changes other characteristics such as an opacity in response to detecting the second input. In some embodiments, the electronic device optionally changes a visual appearance of a checkbox or shape in response to detecting the second input, such as including a color fill in the checkbox or shape and/or changing a color of a border. In some embodiments, in response to detecting the second input, the electronic device maintains display of other representation of other items included in the day. For example, the electronic device optionally maintains the color, position, scale, and/or some combination thereof of representations of calendar events and/or representations of reminder items that are displayed separately from the representation of the first item. Facilitating changing of the reminder item completion status without requiring input to initiate display of a user interface for the reminder application reduces power consumption required to perform operations in accordance with such input, and improves the speed at which the user is able to change statuses of reminder items while viewing the user interface for the calendar application.

It should be understood that the particular order in which the operations in FIG. 9 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 700) are also applicable in an analogous manner to method 900 described above with respect to FIG. 9. For example, the operation of displaying representations of calendar items described above with reference to method 900 optionally has one or more of the characteristics of displaying calendar items such as in accordance with a view of a user interface for a calendar application described herein with reference to other methods described herein (e.g., method 700). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 9 are, optionally, implemented by components depicted in FIGS. 1A-1B. For example, displaying operation 906 and 908, and detecting operation 902 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is tracking and displaying content. The present disclosure contemplates that in some instances, the data utilized may include personal information data that uniquely identifies or can be used to contact or locate a specific person. Such personal information data can include demographic data, event data, content consumption activity, location-based data, telephone numbers, email addresses, twitter ID's, home addresses, data relating to a person's likeness, name, date of birth, or any other identifying or personal information.

The present disclosure recognizes that the use of such personal information data, in the present technology, can be used to the benefit of users. For example, using information from an instance of a calendar to represent the user's schedule. Accordingly, use of such personal information data enables users to use electronic devices to perform enhanced operations with viewing items corresponding to their calendar instances. Further, other uses for personal information data that benefit the user are also contemplated by the present disclosure. For instance, presenting representations of items may remind the user of events and/or items they otherwise are liable to forget.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device optionally displays a representation of a calendar and/or items associated with the calendar without associating the content with personal user data.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with one or more input devices and a display generation component:
while displaying, via the display generation component, a first view of a user interface for a calendar application, displaying a first visual indication associated with a plurality of items corresponding to a first day of the calendar application, wherein a first portion of the first visual indication is associated with one or more items included in a first calendar, and a second portion, different from the first portion, of the first visual indication is associated with one or more items included in a second calendar, different from the first calendar;
while displaying the first visual indication and the first view of the user interface, detecting, via the one or more input devices, one or more first inputs changing a view of the user interface; and
in response to detecting the one or more first inputs:
displaying, via the display generation component, a second view of the user interface, different from the first view of the user interface; and
displaying, via the display generation component, a plurality of second visual indications, different from the first visual indication, wherein a respective first visual indication of the plurality of second visual indications corresponds to the first portion of the first visual indication and is associated with the one or more items included in the first calendar, and wherein a respective second visual indication of the plurality of second visual indications corresponds to the second portion of the first visual indication and is associated with the one or more items included in the second calendar.

2. The method of claim 1, wherein:
the first visual indication indicates a density of the one or more items included in the first calendar and the second calendar, and
the respective first visual indication does not indicate the density of the one or more items included in the first calendar and the second calendar.

3. The method of claim 1, wherein a scale of the first visual indication relative to the user interface corresponds to a density of the one or items included in the first calendar and a density of the one or more items included in the second calendar.

4. The method of claim 1, wherein a quantity of the plurality of second visual indications is based upon a number of the one or more items included in the first calendar and the second calendar.

5. The method of claim 1, displaying the first view of the user interface for the calendar application including the first visual indication includes:
in accordance with a determination that the one or more items included in the first calendar correspond to a first density relative to the first day, displaying the first portion of the first visual indication with one or more first visual characteristics having one or more first values, and
in accordance with a determination that the one or more items included in the first calendar correspond to a second density relative to the first day, different from the first density, displaying the first portion of the first visual indication with the one or more first visual characteristics having one or more second values, different from the one or more first values.

6. The method of claim 5, wherein:
displaying the first portion of the first visual indication includes displaying the first portion with a first visual characteristic having a first value, independently of respective densities of the one or more items included in the first calendar that correspond to the first day and independently of respective densities of the one or more items included in the second calendar that correspond to a second day and,
displaying the plurality of second visual indications and the second view of the user interface includes displaying the respective first visual indication with the first visual characteristic having a respective first value based upon the first value.

7. The method of claim 1, wherein displaying the second view of the user interface and displaying the plurality of second visual indications in response to detecting the one or more inputs includes:
in accordance with a determination that a respective item included in the one or more items included in the first calendar corresponds to a plurality of days including the first day of the calendar application, displaying the respective first visual indication occupying a first region of the second view of the user interface corresponding to the first day of the calendar application and occupying a second region corresponding to a second day of the calendar application, different from the first day, wherein the first region and the second region are contiguous regions of the second view of the user interface.

8. The method of claim 7, wherein displaying the first visual indication while displaying the first view of the user interface for the calendar application includes:
in accordance with the determination that the respective item included in the one or more items included in the first calendar corresponds to the plurality of days including the first day of the calendar application, displaying the first portion of the first visual indication occupying a first region of the first view of the user interface corresponding to the first day of the calendar application and displaying a second visual indication that additionally corresponds to the respective item, different from the first visual indication, occupying a second region corresponding to a second day of the first view of the calendar application, different from the first day.

9. The method of claim 1, further comprising:
while displaying the second view of the user interface, detecting, via the one or more input devices, one or more second inputs changing the view of the user interface; and
in response to detecting the one or more second inputs:
concurrently displaying, via the display generation component, a third view of the user interface, different from the second view and different from the first view of the user interface;
displaying, via the display generation component, a plurality of third visual indications, different from the plurality of second visual indications and different from the first visual indication, wherein a respective first visual indication of the plurality of third visual indications corresponds to the first portion of the first visual indication, and wherein a respective second visual indication of the plurality of third visual indications corresponds to the second portion of the first visual indication; and
displaying, via the display generation component, respective information corresponding to respective items included in the one or more items included in the first calendar, wherein the respective information is different from the plurality of third visual indications, wherein the respective information is not included in the first view of the user interface and is not included in the second view of the user interface.

10. The method of claim 1, wherein the one or more inputs include a request to change the user interface for the calendar application by a first amount, the method further comprising:
while displaying the first view of the user interface for the calendar application, detecting, via the one or more input devices, one or more second inputs, different from the one or more first inputs, wherein the one or more second inputs include a request to change the user interface for the calendar application by a second amount, greater than the first amount; and
in response to detecting the one or more second inputs:
displaying, via the display generation component, the second view of the user interface, different from the first view of the user interface; and
displaying, via the display generation component, the plurality of second visual indications, different from the first visual indication, including the respective first visual indication of the plurality of second visual indications and the respective second visual indication of the plurality of second visual indications.

11. The method of claim 1, wherein the one or more inputs include a request to change the user interface for the calendar application by a first amount, the method further comprising:
while displaying the first view of the user interface for the calendar application, detecting, via the one or more input devices, one or more second inputs, different from the one or more first inputs, wherein the one or more second inputs include a request to change the user interface for the calendar application by a second amount, greater than the first amount; and
in response to detecting the one or more second inputs:
displaying, via the display generation component, a third view of the user interface, different from the first view of the user interface and different from the second view of the user interface; and
displaying, via the display generation component, a plurality of third visual indications, different from the first visual indication and different from the plurality of second visual indications, wherein a respective first visual indication of the plurality of third visual indications corresponds to the respective first visual indication of the plurality of second visual indications, and a respective second visual indication of the plurality of third visual indications corresponds to the respective first visual indication of the plurality of second visual indications, wherein respective information included in the third view of the user interface corresponding to respective items included in the one or more items included in the first calendar is not included in the first view of the user interface and is not included in the second view of the user interface.

12. The method of claim 1, wherein the one or more inputs are one or more scaling inputs.

13. The method of claim 1, wherein:
displaying the first view of the user interface includes displaying a first quantity of representations of days along a first dimension of the user interface and includes displaying a second quantity of representations of days along a second dimension of the user interface, different from the first dimension, and
displaying the second view of the user interface includes displaying the first quantity of representations of days along the first dimension of the user interface and includes displaying a third quantity of representations of days, different from the second quantity, along the second dimension of the user interface, different from the first dimension.

14. An electronic device that is in communication with one or more display generation components and one or more input devices, the electronic device comprising:
one or more processors;
memory; and
one or more programs, wherein the one or more programs are stored in the memory and configured to be executed by the one or more processors, the one or more programs including instructions for:
while displaying, via the display generation component, a first view of a user interface for a calendar application, displaying a first visual indication associated with a plurality of items corresponding to a first day of the calendar application, wherein a first portion of the first visual indication is associated with one or more items included in a first calendar, and a second portion, different from the first portion, of the first visual indication is associated with one or more items included in a second calendar, different from the first calendar;
while displaying the first visual indication and the first view of the user interface, detecting, via the one or more input devices, one or more first inputs changing a view of the user interface; and
in response to detecting the one or more first inputs:
displaying, via the display generation component, a second view of the user interface, different from the first view of the user interface; and
displaying, via the display generation component, a plurality of second visual indications, different from the first visual indication, wherein a respective first visual indication of the plurality of second visual indications corresponds to the first portion of the first visual indication and is associated with the one or more items included in the first calendar, and wherein a respective second visual indication of the plurality of second visual indications corresponds to the second portion of the first visual indication and is associated with the one or more items included in the second calendar.

15. A non-transitory computer readable storage medium storing one or more programs, the one or more programs comprising instructions, which when executed by one or more processors of an electronic device in communication with a display generation component and one or more input devices, cause the electronic device to perform a method comprising:
while displaying, via the display generation component, a first view of a user interface for a calendar application, displaying a first visual indication associated with a plurality of items corresponding to a first day of the calendar application, wherein a first portion of the first visual indication is associated with one or more items included in a first calendar, and a second portion, different from the first portion, of the first visual indication is associated with one or more items included in a second calendar, different from the first calendar;
while displaying the first visual indication and the first view of the user interface, detecting, via the one or more input devices, one or more first inputs changing a view of the user interface; and
in response to detecting the one or more first inputs:
displaying, via the display generation component, a second view of the user interface, different from the first view of the user interface; and
displaying, via the display generation component, a plurality of second visual indications, different from the first visual indication, wherein a respective first visual indication of the plurality of second visual indications corresponds to the first portion of the first visual indication and is associated with the one or more items included in the first calendar, and wherein a respective second visual indication of the plurality of second visual indications corresponds to the second portion of the first visual indication and is associated with the one or more items included in the second calendar.

16-32. (canceled)
